(19) United States
(12) Patent Application Publication
(10) Pub. No.: US 2026/0326680 A1
(43) Pub. Date: Oct. 22, 2026

(54) TIRE CHAIN STORAGE DEVICES FOR VEHICLES EQUIPPED WITH AERODYNAMIC SYSTEMS

(71) Applicant: FlowBelow Aero, Inc., Round Rock, TX (US)

(72) Inventors: Joshua Butler, Austin, TX (US); Roberto Urista, Austin, TX (US); Erik V. Sharp, Austin, TX (US); Miguel Mendoza Sandoval, Austin, TX (US)

(21) Appl. No.: 19/654,128

(22) Filed: Apr. 21, 2026

Related U.S. Application Data
(60) Provisional application No. 63/792,076, filed on Apr. 21, 2025.

(51) Int. Cl. B60R 9/06; B62D 25/16; B62D 35/02

(52) U.S. Cl. CPC B60R 9/06; B62D 25/163; B62D 35/02

(57) ABSTRACT

Tire chain storage devices for vehicles equipped with aerodynamic systems are disclosed. In one embodiment, a tire chain storage device includes a chain hanger support assembly configured for attachment to a vehicle frame member and a chain hanger assembly supported by the support assembly for suspending tire chains. The support assembly may include a mounting bracket and a support member. The chain hanger assembly may include one or more chain hanger hooks configured to be fixed, removable, rotatable, or foldable, and a lid assembly configured to selectively enclose the hooks and chains. In certain embodiments, the tire chain storage device is integrated with or mountable in conjunction with a mud flap hanger or an aerodynamic fairing support, allowing retrofit installation without modification of the vehicle frame.

### RELATED APPLICATIONS

This application claims the benefit of priority under 35 U.S.C. § 119(e) to U.S. Provisional Application No. 63/792,076, entitled “Tire Chain Storage Devices for Vehicles Equipped with Aerodynamic Systems,” filed Apr. 21, 2025, which is hereby fully incorporated by reference herein.

### TECHNICAL FIELD

The present disclosure relates generally to accessories and equipment for heavy duty vehicles, and more particularly to devices for storing tire snow chains on such vehicles. More particularly, the present disclosure relates to chain hangers and storage assemblies. Even more particular embodiments relate to chain hangers and storage assemblies configured for use on semi-trucks and other commercial vehicles, including configurations that interface with mud flaps, aerodynamic fairings, and vehicle frame structures.

### BACKGROUND

Tire snow chains are commonly required for commercial vehicles operating in mountainous, northern, or winter-weather regions. Various state and provincial regulations mandate that drivers carry a prescribed number of tire chains during certain times of the year and under specified road conditions. Tractor trailers (also referred to as semi-trucks) must typically carry a full compliant set of chains, each sized for heavy-duty truck tires. Collectively, these chains are bulky, cumbersome, and can weigh several hundred pounds.

As a result, snow chains are typically stored externally on the vehicle rather than inside the cab. External storage reduces safety hazards within the cab, prevents interior damage, and allows drivers quicker access when chaining is required. One common solution is a tire chain hanger, typically formed from steel components and mounted to the truck frame. Such hangers usually include a plurality of hooks for suspending chains and may include a hinged or removable lid intended to reduce debris buildup or prevent chains from dislodging during travel.

Conventional chain hangers are most often mounted to the vehicle frame forward of the drive axles and rearwards of the cab. While these devices are widely used, they exhibit numerous drawbacks that have become increasingly problematic as truck designs and fleet priorities evolve. One significant limitation of such chain hangers is space availability on the truck frame. Over time, semi-truck designs have trended toward shorter wheelbases and more compact frame layouts to reduce weight and improve maneuverability. As a result, many trucks lack sufficient unobstructed frame real estate to accommodate conventional frame-mounted chain hangers. In some cases, installers must drill new holes in the frame or forgo mounting a hanger entirely, leading to compliance challenges or suboptimal chain storage solutions.

Existing hangers are also structurally monolithic, often welded as a single left-hand or right-hand assembly. If a component, such as a hook, lid, or mounting arm, is bent or damaged due to curb strikes, backing incidents, road debris, or routine contact with trailers and loading docks, the entire hanger often must be replaced. This replacement can be costly and time consuming, particularly where the hanger is frame mounted and requires removal of heavy hardware. The inability or difficulty to repair or replace components increases maintenance costs for fleets and discourages repair.

Another drawback is the interaction between chain hangers and mud flaps. In hanger designs located behind the drive wheels, the chain hanger frequently occupies the same space as the mud flap hanger, requiring special integrated designs. Many existing solutions fail to adequately isolate these functions, such that impacts to the mud flap or its hanger can transmit damaging forces to the chain hooks or storage structure. Conversely, servicing or replacing a mud flap may require disturbing the chain hanger assembly.

A further limitation arises from the seasonal nature of snow chain usage. Many fleets are required to carry chains for only part of the year, and in practice may deploy chains rarely or not at all. Conventional chain hangers remain permanently mounted to the vehicle regardless of seasonal need, adding unnecessary weight, protruding structural elements, and exposure to impact during non-winter operation. In addition, protruding chain hooks can extend generally laterally from the truck, increasing the likelihood of damage when chains are not present.

Relatedly, existing chain hangers typically do not provide an efficient method for removing and storing the hanger itself, with or without attached chains, during off season periods. Removing individual chains from a hanger is labor intensive, and storing loose chains consumes valuable warehouse space. Known systems lack a practical approach for temporarily removing or storing the entire hanger assembly in a compact manner.

However, these chain hangers are incompatible with aerodynamic systems designed to reduce drag of air flowing off the drive wheels. Semi-trucks travel significant distances every year. Consequently, the cumulative effect of even incremental amounts of drag on a tractor-trailer can lead to significant increases in overall operating costs. While various fairings have been developed in recent years to help mitigate drag, conventional chain hangers are incompatible with these fairings.

Another drawback is the interaction between chain hangers and mud flaps. In hanger designs located behind the drive wheels, the chain hanger is integrated with the mud flap hanger. Existing solutions fail to adequately isolate these functions, such that impacts to the mud flap or its hanger can transmit damaging forces to the chain hanger. Conversely, servicing or replacing a mud flap may require disturbing the chain hanger assembly.

A further limitation arises from the seasonal nature of snow chain usage. Many fleets are required to carry chains for only part of the year, and in practice may deploy chains rarely or not at all. Conventional chain hangers remain permanently mounted to the vehicle regardless of seasonal need, adding unnecessary weight, protruding structural elements, and exposure to impact during non-winter operation. In addition, protruding chain hooks can extend generally laterally from the truck, increasing the likelihood of damage when chains are not present.

Another emerging challenge is the integration of chain storage with aerodynamic systems. Modern semi-trucks increasingly rely on aerodynamic fairings, including rear wheel fairings and underbody devices, to improve fuel efficiency and reduce emissions. These aerodynamic components often occupy the same mounting zones as conventional chain hangers, resulting in conflicts that prevent installation of one system or the other. Existing chain hangers are generally not designed to accommodate aerodynamic fairings, nor do they offer provisions for removable, repositionable, or storable fairing components when tire chains are installed.

In addition, current chain hanger designs provide little flexibility in terms of configuration, adjustability, or adaptability across different vehicle types and fleet requirements. Variations in regulatory requirements, number of chains carried, vehicle dimensions, and accessory layouts often necessitate different hanger designs or multiple part numbers, increasing manufacturing and inventory complexity.

Accordingly, there exists a need for improved tire chain storage devices that address one or more of the foregoing disadvantages. In particular, there is a need for chain hangers that are modular, serviceable, adaptable to constrained frame spaces, compatible with mud flaps and aerodynamic fairings, and capable of being removed or reconfigured based on seasonal use—while maintaining compliance with safety and regulatory requirements for heavy duty vehicles.

### SUMMARY OF THE DISCLOSURE

Embodiments of the present disclosure provide systems and methods for storing snow chains, particularly for commercial vehicles, such as semi-trucks. One general aspect includes a tire chain storage device for a vehicle. The tire chain storage device also includes a chain hanger support configured for attachment to a frame member of the vehicle. The chain hanger support may include a chain hanger support member and a mounting bracket configured to secure the chain hanger support to the frame member. The device also includes a chain hanger assembly mounted to the chain hanger support and may include a plurality of chain hanger hooks configured to support tire chains in a suspended condition.

Another aspect of the present disclosure includes a modular tire chain hanger device. The modular tire chain storage device may include a chain hanger support member. In some embodiments, the chain hanger support member comprises an extension bracket. The extension bracket includes, in some embodiments, at least one of the following: the fairing mounting interface or a support area for attachment of a mud flap. The chain hanger device may further include a mounting bracket configured to secure the chain hanger support member to a frame member. The device also includes a chain hanger assembly mounted to the chain hanger support member and comprising a plurality of chain hanger hooks configured to support tire chains in a suspended condition.

Another aspect of the present disclosure includes a tire chain hanger device with orientation independent components. A chain hanger device may include a chain hanger support configured for attachment to a frame member of the vehicle. According to one embodiment, the chain hanger support comprises a first support member and a mounting bracket, the mounting bracket configured to secure the chain hanger support to a frame member. In certain embodiments, at least one of the first support member or the mounting bracket is symmetrically configured such that its geometry is orientation-independent relative to a vertical transverse plane of the vehicle. The chain hanger device includes a chain hanger assembly mounted to the chain hanger support and comprising a plurality of chain hanger hooks configured to support tire chains in a suspended condition.

Implementations may include one or more of the following features. The tire chain storage device where the mounting bracket includes a frame interface plate adapted to be sandwiched between the frame member and another component such as a mud flap hanger or a fairing support arm. The chain storage device includes a fairing mounting interface. The tire chain storage device where the chain hanger support includes a mudflap support. The chain hanger support is adapted to hang an angled mud flap. The support member includes: a first support member having an inboard end coupled to the mounting bracket; and an extension bracket coupled to the first support member. The extension bracket includes a fairing mounting interface. The extension bracket is coupled to the first support member at a bracket hinge and is rotatable from a primary position to a secondary position. The primary position may correspond to a fairing aerodynamic position. The secondary position may correspond to a secondary position of the fairing. The extension bracket is lockable in at least one of the primary position or the secondary position. The extension bracket includes a working end and a heel, where the heel is releasably securable to the first support member when the extension bracket is in the primary position. The extension bracket is removable from the chain hanger support. The working end may carry a fairing mounting interface. The fairing mounting interface may have a generally longitudinal outboard surface when the extension bracket is in the primary position. At least one of the first support member or the mounting bracket is symmetrically configured such that its geometry is orientation-independent relative to a vertical transverse plane of the vehicle. The fairing mounting interface is configured to mount at least one of a rear fairing or a quarter fairing. At least one of the chain hanger hooks is removable. At least one of the chain hanger hooks is rotatable between an operational position and a storage position. A first hanger hook from the plurality of chain hanger hooks may include a shank that passes through the hook collar and a keying feature, and where the first hanger hook is movable between the operational position in which the keying feature is matingly engaged with a first indexing notch and the storage position in which the keying feature is matingly engaged with a second notch. The first hanger hook has a tip and where the hanger lid has a first hook access aperture adapted to align with the tip of the first hanger hook when the first hanger hook is in the operational position and a second hook access aperture adapted to align with the tip of the first hanger hook when the first hanger hook is in the storage position. The chain hanger assembly is configured to be stored off-vehicle with tire chains supported thereon. The support member is separable from the mounting bracket. The chain hanger assembly is configured to be removable from the vehicle as a unit with the chain hanger hooks attached. The mounting bracket includes mounting apertures compatible with a mounting hardware pattern of the mud flap hanger or the fairing support arm. The mounting bracket includes one or more open ended mounting slots configured to permit installation without removing existing mounting hardware from the frame member.

### BRIEF DESCRIPTION OF DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features.

FIG. 1 is a diagrammatic perspective view of one embodiment of a tire chain storage device mounted to a vehicle frame rail behind the rear wheels of a vehicle.

FIG. 2 is a top view of the tire chain storage device of FIG. 1 mounted to the vehicle frame.

FIG. 3 is a rear view of the tire chain storage device of FIG. 1 mounted to the vehicle frame.

FIG. 4 is an elevated side view of the tire chain storage device of FIG. 1.

FIG. 5 is an exploded view of the tire chain storage device of FIG. 1.

FIG. 6 is a side view of the tire chain storage device of FIG. 1.

FIG. 7 is a diagrammatic representation of a splash suppression system and a tire chain storage device mounted behind the drive wheels of a vehicle in accordance with one embodiment.

FIG. 8 is a side elevational view of one embodiment of a tire chain storage device mounted to a vehicle frame.

FIG. 9 is a rear view of the tire chain storage device of FIG. 8.

FIG. 10 is a side of another embodiment of a tire chain storage device.

FIG. 11 is a diagrammatic outboard-side view of one embodiment of a chain storage device having chain hanger hooks in an extended, operational position.

FIG. 12 is a diagrammatic view of the chain storage device of FIG. 11 with the chain hanger hooks in a folded or stored position.

FIG. 13 is a diagrammatic cross-sectional view of the chain storage device of FIG. 11.

FIG. 14 is a diagrammatic exploded view of the chain storage device of FIG. 11.

FIG. 15 is a diagrammatic representation of one embodiment of a chain hanger fairing bracket.

FIG. 16 is a diagrammatic representation of another embodiment of a tire chain storage device including a pivotable or hinged extension bracket.

FIG. 17 is another view of the tire chain storage device of FIG. 16 illustrating repositioning of an extension bracket.

FIG. 18 is a further diagrammatic view of the tire chain storage device of FIG. 16.

FIG. 19 is a diagrammatic representation of another embodiment of a tire chain storage device including an integrally formed support member.

FIG. 20 is another view of the tire chain storage device of FIG. 19.

FIG. 21 is a diagrammatic representation of the tire chain storage device of FIG. 19 with an alternative extension bracket.

FIG. 22 is a diagrammatic representation of a rotatable or foldable chain hanger hook according to one embodiment.

FIG. 23 is a diagrammatic representation of another embodiment of a foldable or pivotable chain hanger hook secured by a locking pin mechanism.

FIG. 24 is a diagrammatic representation of another embodiment of a foldable chain hanger hook using a notched collar.

FIG. 25 is a diagrammatic representation of another embodiment of a foldable chain hanger hook including a threaded retention arrangement.

FIG. 26 is a diagrammatic representation of another embodiment of a foldable chain hanger hook including a removable indexing cap.

FIG. 27 is a diagrammatic representation of one embodiment of a fairing.

### DETAILED DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

As used herein, terms such as “lateral,” “longitudinal,” “inboard,” “outboard,” “forward,” “rearward,” to describe the relative positions of components of the invention with respect to a standard vehicle frame or a ground surface. Unless otherwise specified, these terms refer to the orientation of the device as it would be typically installed for use on a vehicle. In this context, “longitudinal” generally refers to a direction extending in a forward-to-rearward direction of the vehicle, and “lateral” generally refers to a direction extending in a side-to-side direction of the vehicle. These directional references are intended to assist in understanding the illustrated embodiments and are not limiting.

Such directional terminology does not require a particular orientation of the disclosed devices or components. The embodiments described herein may be installed in orientations different from those shown, and the use of directional terminology does not restrict the scope of the disclosure or the claims. Unless expressly stated otherwise, such terms are not intended to define absolute positions, directions relative to gravity, or fixed spatial relationships.

Further, terms of degree such as “about,” “approximately,” “generally,” “substantially,” “proximate,” and similar expressions, when used herein, are intended to account for variations that occur in manufacturing, installation, material properties, and operational conditions. Such terms are not intended to denote exact dimensions, angles, shapes, or positions, but rather to encompass values or configurations that achieve the described functional result. Unless expressly stated otherwise, the use of terms of degree should not be interpreted as limiting the scope of the disclosure or the claims to a precise value, arrangement, or geometry. Specifically, in the context of geometric relationships (e.g., “substantially parallel” or “substantially perpendicular”), these terms include minor deviations from the perfect geometric orientation caused by manufacturing tolerances, material thermal expansion, or mechanical play.

It is contemplated that the various features, structures, and functional characteristics described in relation to any one embodiment herein may be combined with the features, structures, and functional characteristics of any other embodiment without departing from the scope of the disclosure. The presentation of a feature in a specific drawing is intended to be exemplary and not limiting; the invention may be practiced with any combination of the described elements.

Embodiments of the present disclosure provide tire chain storage devices configured for use on heavy-duty vehicles, such as tractor-trailer combinations and other commercial vehicles. In particular, the disclosed embodiments generally relate to chain hanger assemblies that are mountable to a vehicle frame and configured to support, store, and retain tire snow chains in an external location on the vehicle. The disclosed embodiments further address integration with mud flap hangers, aerodynamic fairings, and other vehicle components commonly located near the drive wheels.

In one embodiment, a tire chain storage device includes a chain hanger support assembly configured to attach to a vehicle frame member, such as a frame rail, and a chain hanger assembly coupled to the support assembly for suspending one or more tire chains. The chain hanger support assembly may include a mounting bracket configured for attachment to the frame and a support member or support arm extending generally laterally from the frame to position the chain hanger assembly. The chain hanger assembly may include one or more chain hanger hooks configured to support tire chains in a suspended condition, as well as a lid assembly configured to selectively enclose the hooks and chains.

In certain embodiments, the chain hanger support assembly is configured to integrate with or cooperate with splash suppression systems, mud flap hangers, or aerodynamic fairing support arms. For example, some embodiments permit the chain hanger mounting bracket to be installed using the same mounting hardware as a conventional mud flap hanger or fairing support arm, allowing the tire chain storage device to be retrofitted onto a vehicle without drilling new holes in the frame. In other embodiments, the chain hanger support member itself functions as a mud flap hanger or fairing support arm, thereby consolidating multiple vehicle components.

Certain embodiments further provide for compatibility with aerodynamic fairings, such as rear wheel fairings or quarter fairings. In these embodiments, the chain hanger support member may include a fairing mounting interface or extension bracket for supporting an aerodynamic fairing. The fairing may be mounted in a fixed, adjustable, removable, or pivotable manner, allowing the fairing to occupy a primary aerodynamic position during normal operation and to be repositioned or stowed when tire chains are installed or when additional clearance is required.

In some embodiments, the tire chain storage device is configured to be modular and serviceable, such that portions of the device, such as the chain hanger frame, hooks, or lid, may be removably attached. This modularity allows components subject to wear or impact to be replaced individually and, in some embodiments, allows the chain hanger frame and hooks to be removed from the vehicle as a unit for off-season storage, optionally with the tire chains remaining supported thereon. This modularity also allows different configurations of the tire chain storage device to be assembled, such as one configuration that is compatible with a rear fairing, and another version that is not.

The chain hanger hooks disclosed herein may be fixed, removable, rotatable, foldable, or indexed, depending on the embodiment. For example, certain embodiments include hooks configured to pivot or fold between an extended, chain-supporting position and a folded or retracted position to reduce the profile of the device when chains are not in use. In some embodiments, the hooks cooperate with collars or indexing features to define discrete angular positions and to inhibit free swinging during vehicle operation.

The lid assembly may be hinged, removable, or configured with quick-release features, and may include apertures or interfaces that cooperate with one or more chain hanger hooks to lock the lid in a closed position. In some embodiments, the lid is interchangeable between left-side and right-side installations and may be formed from lightweight or corrosion-resistant materials. The lid may also include a contoured or aerodynamic outer profile to improve airflow relative to conventional flat chain hanger lids.

While several embodiments are described with reference to specific configurations, materials, and component arrangements, it will be understood that the various features and aspects of the disclosed embodiments may be combined, rearranged, or modified without departing from the spirit and scope of the disclosure. The following detailed description, taken in conjunction with the accompanying drawings, further illustrates non-limiting examples of these embodiments.

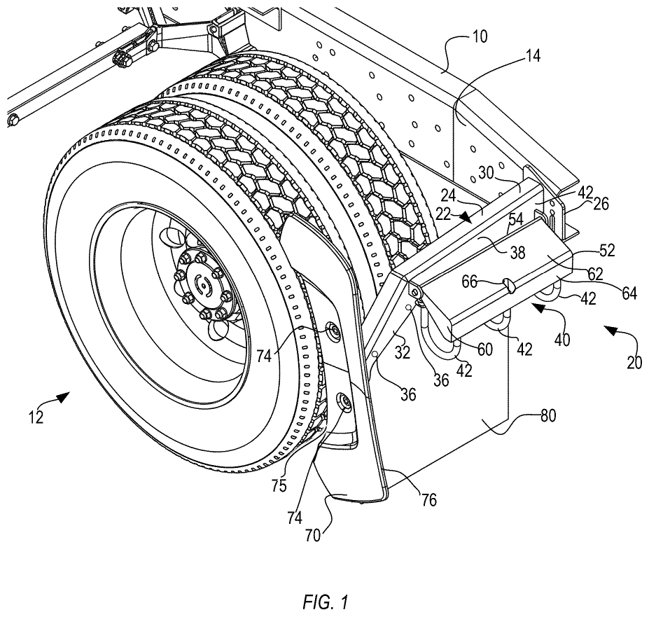

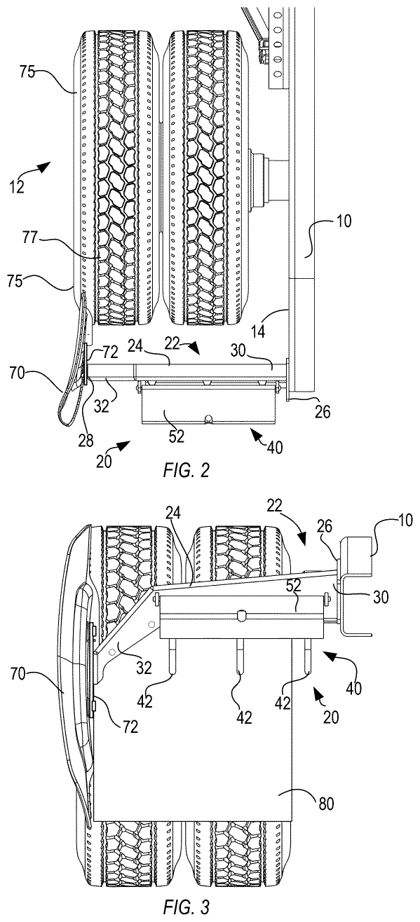

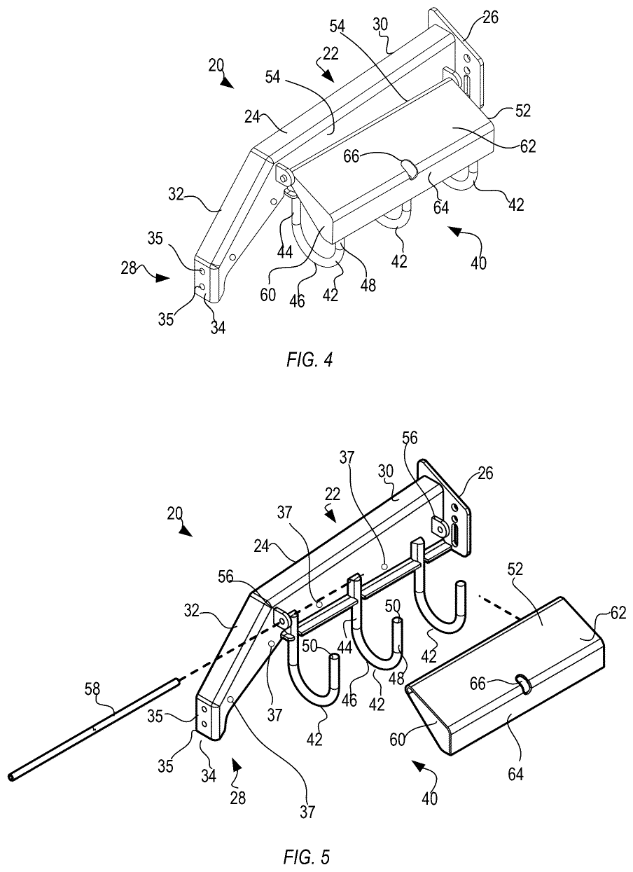

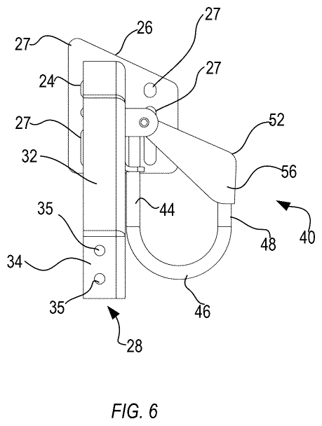

The FIG. 1 is a diagrammatic representation of one embodiment of a tire chain storage device 20 mounted to a frame member 10 of a vehicle, which provides a mechanical ground for the tire chain storage device 20. Even more particularly, FIG. 1 illustrates the chain storage device 20 mounted to a frame rail of a tractor trailer combination (semi-truck) behind the rear wheels 12. FIG. 2 illustrates a top view of the chain storage device 20 mounted to the frame member 10. FIG. 3 illustrates a rear view of the chain storage device 20 mounted to the frame member 10. FIG. 4 is a diagrammatic representation of embodiment of the chain storage device 20. FIG. 5 illustrates an exploded view of the chain storage device 20. FIG. 6 illustrates a side view of the chain storage device 20.

The tire chain storage device 20 includes a chain hanger support assembly 22 configured for attachment to a vehicle frame member 10. In the illustrated embodiment, the chain hanger support assembly 22 includes a chain hanger support member 24 and a chain hanger mounting bracket 26. The chain hanger mounting bracket 26 is configured to structurally support and secure the tire chain storage device 20 relative to the frame member 10. The chain hanger mounting bracket 26 may be formed integral with or be permanently or removably coupled to the chain hanger support member 24. In some embodiments, the chain hanger mounting bracket 26 may be suitable for left and right-side installations. The chain hanger mounting bracket 26 may include a frame interface plate adapted to be positioned adjacent to the frame member 10, the frame interface plate including one or more mounting apertures 27 for receiving bolts, pins, studs, clamps, or other mounting hardware (not shown), thereby permitting the tire chain storage device 20 to be removably or permanently secured to the vehicle frame member 10 in a selected orientation. In other embodiments, the chain hanger mounting bracket 26 may be attached to the frame member 10 through welding or other attachment mechanism.

As shown, the chain hanger mounting bracket 26 is arranged for attachment to an upright face 14 of the frame member 10. However, the chain hanger mounting bracket 26 is not limited to this configuration and may be formed in, or adapted to assume, a variety of alternative geometries, orientations, and mounting positions. By way of non-limiting example, the chain hanger mounting bracket 26 may be configured for attachment to an upper surface, lower surface, side surface, interior surface, or exterior surface of the frame member 10, and may further be configured for attachment to structural members adjacent to or supported by the vehicle frame. The chain hanger mounting bracket 26 may include generally planar, angled, L-shaped, U-shaped, multi-flanged, or contoured portions, and may be oriented horizontally, vertically, diagonally, or in a compound orientation relative to the frame member 10, depending on vehicle configuration, available mounting space, and installation requirements.

The chain hanger mounting bracket 26 may have a variety of form factors and, by way of example and not limitation, may form a socket or double-shear structure for receiving an inboard end of the chain hanger support member 24. Further, various mechanisms for mounting a support arm to a frame rail as described in U.S. Pat. No. 9,027,983, entitled “Aerodynamic System and Adjustable Fairings,” filed Nov. 1, 2013, the entirety of which is hereby incorporated by reference herein, may be adapted to mount the chain hanger support member 24 to the frame member 10, including but not limited to, joints that allow an arm to rotate about an axis of rotation defined by the joint or spring biasing mechanisms that allow the arm to deflect relative to the base (e.g., chain hanger mounting bracket 26) or vehicle frame. In some embodiments, the inboard end of the chain hanger support member 24 may attach to the chain hanger mounting bracket 26, without tools, such as with the use of telescoping tubing and snap-pins as is used for some mud flap hangers in the art.

In the illustrated embodiment, the chain hanger support member 24 is formed as a support arm coupled to the chain hanger mounting bracket 26 at a first end and extending generally laterally to a second end 28 configured for mounting an aerodynamic fairing 70. The chain hanger support member 24 may have a variety of form factors and may, for example, comprise a plate, an L-beam, a tube with a rectangular, circular, or other tubular cross-section, or a generally U-shaped or otherwise contoured profile. In the illustrated embodiment, the chain hanger support member 24 includes a first leg 30 positioned proximately to the frame member 10 and extending generally laterally outward from the frame member 10, for example in a generally horizontal direction, and a second leg 32 extending generally laterally out and down from the first leg 30 at a selected angle, such as approximately forty-five degrees or another suitable angle. In other embodiments, the chain hanger support member 24 may be substantially straight, curved, or follow other paths suitable for the intended mounting location and vehicle configuration. In some embodiments, the chain hanger support member 24 may comprise multiple components and may, for example, comprise a telescoping arm.

In certain embodiments, the chain hanger support member 24 is rigidly coupled to the chain hanger mounting bracket 26. In other embodiments, the chain hanger support member 24 comprises a spring-biased arm member configured to deflect under impact loads in order to protect the fairing 70 and the tire chain storage device. By way of example, the chain hanger support member 24 may be a spring-loaded support arm that is coupled to the chain hanger mounting bracket 26 using one or more spring elements that bias the chain hanger support member 24 toward the chain hanger mounting bracket 26 or the frame member 10 while permitting relative deflection between the chain hanger support member 24 and the chain hanger mounting bracket 26 or the frame member 10. In some embodiments, the tire chain storage device 20 may incorporate a spring-biasing mechanism that allows deflection between a support arm and a base or vehicle, as described in U.S. Pat. No. 9,027,983, entitled “Aerodynamic System and Adjustable Fairings,” filed Nov. 1, 2013, the entirety of which is hereby incorporated by reference herein, to allow the chain hanger support member 24 to deflect relative to the frame member 10.

In the illustrated embodiment, the second end 28 of the chain support assembly 22 includes structure configured to accommodate mounting of the fairing 70 either directly or through an intermediate adapter. For example, the second end 28 of the chain hanger support member 24 may include a fairing mounting interface 34 having one or more mounting apertures 35 configured to receive bolts, pins, studs, clamps, or other mounting hardware (not shown), thereby permitting the fairing 70 to be mounted to the chain hanger support member 24. In certain embodiments, mounting apertures formed in the fairing 70 may not align with the mounting apertures of the fairing mounting interface 34. Accordingly, an adapter 72, such as an adapter plate, may be provided. The adapter 72 may include a first pattern of apertures configured to align with mounting apertures of the fairing 70 and a second pattern of apertures configured to align with the mounting apertures of the fairing mounting interface 34. In such embodiments, the adapter 72 may be secured to the fairing mounting interface 34 using first mounting hardware, and the fairing 70 may be secured to the adapter 72 using second mounting hardware 74.

The aperture patterns formed in the adapter 72 may be arranged to permit the adapter 72 to be selectively mounted in multiple horizontal, vertical, or rotational positions relative to the fairing mounting interface 34, or to permit the fairing 70 to be selectively mounted in multiple horizontal, vertical, or rotational positions relative to the adapter 72. In this manner, the position and orientation of the fairing 70 may be adjusted as desired. In other embodiments, the adapter 72 may provide only a single mounting position. In yet other embodiments, the fairing 70 may be mounted directly to the fairing mounting interface 34 in a single position or in multiple selectable positions.

In other example embodiments, the adapter 72 may comprise a post, extension, or other engagement feature configured to slide into, over, or onto the second end 28 of the chain hanger support member 24. The relative position of the adapter 72 may be secured using one or more quick-release retention elements or removable connectors, such as pins, clips, or equivalent structures. In some embodiments, the adapter 72 may be securable in multiple discrete positions, for example via a telescoping interface between the adapter 72 and the chain hanger support member 24.

The foregoing embodiments are illustrative only, and various means for mounting an aerodynamic fairing to a support structure may be used to mount the fairing 70. Such means for mounting may include one or more fairing mounting members operably coupled to or integrally formed with a distal portion of the chain hanger support member 24. By way of non-limiting example, the fairing mounting members may include adapter plates, brackets, posts, interfaces, or combinations thereof, having mounting apertures, configured to receive fasteners securing the fairing 70. In certain embodiments, the mounting members include an adapter having an extension configured to slide into or over the second end 28 of the chain hanger support member 24. The fairing mounting members may include multiple attachment locations to permit selective positioning or adjustment of the fairing 70 relative to the chain hanger support member 24. In further embodiments, the means for mounting includes a pivotable or hinged mounting adapter configured to allow the fairing 70 to move between an operational aerodynamic position and a clearance or stowed position. In still further embodiments, the fairing mounting members include telescoping members, quick-release retention elements, or removable connectors, such as pins or detents, permitting tool-less attachment, removal, or repositioning of the fairing. The fairing mounting members may be rigid, adjustable, removable, foldable, or combinations thereof, and may be secured using bolts, pins, clamps, or other mounting hardware. Certain embodiments may employ adapters or mounting arrangements of the types described in U.S. Pat. No. 9,027,983 to mount the fairing 70 to the chain hanger support member 24.

In certain embodiments, the distal portion of the chain hanger support member 24, such as the second leg 32, may be movably connected to a remainder of the chain hanger support member 24, such as the first leg 30, by a hinge or other articulating mechanism. Such a movable connection permits the fairing 70 to be repositioned from a primary or aerodynamic position, for example as illustrated in FIGS. 1-3, to a secondary position that provides additional clearance for installing the tire chains or for accommodating operation while the tire chains are installed. The secondary position may be located rearward of, above, below, or otherwise offset from a chain storage location. In certain embodiments, the chain hanger support member 24 includes one or more retention features configured to selectively retain the fairing 70 in the primary position, the secondary position, or both. In addition, or in the alternative, the chain hanger support member 24 may comprise multiple interconnected portions configured to telescope relative to one another, thereby permitting adjustment of a distance between the fairing 70 and the chain hanger mounting bracket 26 or the frame member 10.

The aerodynamic fairing 70 is designed to reduce drag when it is in its primary position compared to not having the fairing. The aerodynamic fairing may have a variety of form factors including, but not limited to, those described in U.S. Pat. No. 9,027,983. In one embodiment, the fairing 70 has a leading edge, a trailing edge, a top edge, and a bottom edge. The fairing 70 may include a pattern of holes that allow mounting of the fairing. The leading edge may have a curved portion for accommodating the profile of a wheel. The fairing may be shaped to have a continuous aerodynamic surface from the leading edge to the trailing edge to promote attached flow across the surface. According to one embodiment, the fairing may be shaped to direct airflow over a first surface portion, over a transition area, over a second surface portion or some combination. In one embodiment, the first surface portion may be formed as a relatively flat surface, the transition area may be formed as a discrete or stepped transition zone transitioning from the first surface portion to a second surface portion, and the second surface portion may be formed as an angled or curved outward surface. The fairing may include more or fewer surfaces, areas or zones as needed and in some embodiments may have flat outer surfaces. Curves may be compound or simple, and stepped areas may include more than one step. The inner surface of the fairing may provide a flat mounting zone that may abut an outboard face of the chain hanger support member 24 or an adapter 72. An area of increased thickness may be disposed in front of the mounting zone to provide additional support. The front face of the area of increased thickness may be curved.

The outward position of the fairing 70 may be controlled by selecting a fixed length arm (e.g., the chain hanger support member 24) of the desired length, adjusting the length of an adjustable length arm (e.g., an adjustable chain hanger support member 24), offsetting the chain hanger support member from the frame member 10, selecting the thickness of the fairing 70 to ensure proper positioning and configuration of the fairing 70, selecting the adapter 72 or position of the adapter, or otherwise controlling the position of the fairing. In a preferred embodiment, the fairing 70 is configured to have the leading edge positioned inboard of the outboard edge 76 of the adjacent tire 75 and outboard of the tread 77 of the tire as illustrated in FIG. 2. However, a fairing adjusted to other positions that are too far inboard or too far outboard may still provide benefits over not having fairing 70 at all.

While the fairing 70 of FIG. 1 is a rear fairing, in other embodiments, the chain hanger support member 24 may be adapted to support a quarter fairing or other fairing. Non-limiting examples of quarter fairings and supports for quarter fairings are described in U.S. Pat. No. 8,814,253, entitled “Aerodynamic Quarter Fender Assembly and Construction Method,” filed Apr. 20, 2021, which is hereby incorporated in its entirety herein.

The lower portion of the chain hanger support member 24 comprises a mud flap support to which a mud flap 80 may be attached. In some embodiments, the mud flap support may include a channel into which the top of a mud flap may be inserted. The mud flap support portion may include apertures 37 to accommodate mounting hardware 36 (e.g., bolts, screws or other mounting hardware) for mounting the mud flap 80. In the illustrated embodiment, the chain hanger support member 24 forms an angled mud flap hanger for an angled mud flap (sometimes referred to as 45-degree mud flap, though the mud flap corner may have other angles). In other embodiments, the chain hanger support member 24 may be straight or otherwise shaped to accommodate non-angled (straight bar) mud flaps, shortened mud flaps, or other splash suppression elements.

The tire chain storage device 20 includes a tire chain hanger assembly 40 coupled to the chain hanger support member 24. In the illustrated embodiment, the chain hanger assembly 40 is mounted to an upright rear surface 38 of the chain hanger support member 24. In other embodiments, the chain hanger assembly or portions thereof may mount to or otherwise be supported by a front surface, an upper surface, a lower surface or other portion of the chain hanger support member 24. The chain hanger assembly 40 includes a plurality of spaced chain hanger hooks 42 configured to support and retain tire chains in a suspended condition. Each chain hanger hook 42 may be fixed in position, removable, rotatable, or foldable relative to the chain hanger support member 24, depending on the embodiment. While three chain hanger hooks 342 are illustrated other embodiments may include more or fewer hooks.

One or more of the chain hanger hooks 42 may be formed with various cross-sectional geometries. In some embodiments, a chain hanger hook 42 is formed from a rod or bar having a generally circular cross-section, such as a bent steel rod. In other embodiments, the chain hanger hook 42 is formed from a rectangular, square, or other non-circular bar, which may be bent about one or more axes to form the shank 44, bend 46, and return portion 48. Rectangular or square cross-sections may provide increased resistance to twisting or deformation under load. In further embodiments, combinations of cross-sectional shapes may be used along different portions of the hook. In some embodiments, the chain hanger assembly 40 includes hooks having different configurations (e.g., different cross-sections, one or more hooks may be rotatable, while one or more hooks are fixed, etc.).

One or more chain hanger hooks 42 may include a retention feature associated with the throat or tip region, such as a locking aperture, recess, notch, projection, or engagement surface configured to receive a pin, clip, strap, or other securing element to inhibit accidental chain dislodgement. In other embodiments, the hooks rely on gravitational retention and hook geometry alone to retain the chain.

One or more of the chain hanger hooks 42 may be formed as a unitary, one-piece component or as an assembly of multiple components, and may be fabricated from steel, alloy steel, stainless steel, forged metal, cast metal, or other materials suitable for supporting heavy tire chains and resisting deformation under impact loads.

Each chain hanger hook 42 may comprise an elongated shank 44, a bend 46, and a return portion 48, collectively defining a load-bearing hook geometry suitable for supporting the weight of tire chains during transport and use. According to one embodiment, the shank 44 defines a generally straight or gently contoured portion of the chain hanger hook 42 that is fixedly or moveably mounted to the chain hanger support member 24. The shank may include or engage with one or more mounting features, such as apertures, threaded sections, flattened regions, collars, to facilitate attachment to the chain hanger support member 24. In some embodiments, the shank 44 is welded or otherwise rigidly secured to the chain hanger support member 24 (e.g., surface 38). In other embodiments, the shank 44 extends through or is received by a collar member projecting from the chain hanger support member 24. The chain hanger hook 42 may be fixed to the collar member, for example by welding or other attachment means, or may be pivotable, rotatable or removable relative to the collar member. Thus, in some embodiments, one or more of the chain hanger hooks 42 may be selectively moved between an extended, chain-supporting position and a folded or retracted position in which the chain hanger hook 42 occupies a reduced profile. The foldable configuration may be achieved by a rotational interface (e.g., hinge) between the shank 44 and the chain hanger support member 24, and may rely on gravity, detents, stops, or retention elements to maintain the chain hanger hook 42 in a selected position. Accordingly, the chain hanger assembly 40 may incorporate fixed, rotatable or otherwise foldable, or removable chain hanger hooks 42, including configurations described in further embodiments herein.

The shank 44 transitions into a bend 46 that redirects the chain hanger hook 42 from the shank to a return portion 48 that returns upward to form an open region or throat configured to receive a tire chain. The bend 46 may be arcuate, defining a smooth, continuously curved profile, or may be formed by one or more angular bends, corners, or facets defining a sharper change in direction. The bend 46 defines, in cooperation with the shank 44 and the return portion 48 defines a throat opening sized to permit insertion and removal of chain links while inhibiting unintended disengagement due to vibration or vehicle motion. In some embodiments, the chain hanger hook 42 may have a reinforced throat. For example, the chain hanger hook 42 may be a gusseted hook in which there is a small gusset welded into the bend 46 to prevent the hook from straightening out under the weight of several hundred pounds of steel chain.

The return portion 48 extends from the bend to a terminal end 50, referred to as the tip. The tip 50 may be rounded, chamfered, radiused, blunt, flattened, or otherwise shaped to reduce stress concentration, minimize wear on the tire chain, and limit the likelihood of snagging adjacent components.

The chain hanger assembly 40 includes a lid assembly comprising a hanger lid 52 operably coupled to the chain hanger support member 24 by a lid hinge 54. In the illustrated embodiment, the lid hinge 54 defines a generally horizontal axis of rotation about which the hanger lid 52 may pivot between an open position and a closed position. In one embodiment, the lid hinge 54 comprises a pair of clevis tabs 56 projecting from the chain hanger support member 24, with a hinge pin 58 extending between the clevis tabs 56 and passing through corresponding openings formed in side panels 60 of the hanger lid 52 to rotatably secure the hanger lid 52 to the chain hanger support member 24.

The hanger lid 52 may have a variety of form factors. In the illustrated embodiment, the hanger lid 52 includes an upper panel 62, a distal panel 64 positioned distal from the hinge 54 and opposing side panels 60 extending downward from the upper panel 62 when the hanger lid 52 is in the closed position. In some embodiments, the distal panel 64 and the side panels 60 extend below the tips 50 of the chain hanger hooks 42 when the hanger lid 52 is closed, thereby partially enclosing the chain hanger hooks 42 and tire chains supported thereon.

The hanger lid 52 may include one or more hook access apertures through which a portion of a respective chain hanger hook 42 is exposed when the hanger lid 52 is in the closed position. One or more of the chain hanger hooks 42 may act as a lid looking hook. In the illustrated embodiment, the hanger lid 52 includes a hook access aperture 66 through which a tip region of a selected chain hanger hook 42 (a lid locking hook) is exposed. The exposed tip region of the chain hanger hook 42 may include an aperture or other feature configured to receive a pin, padlock, or other locking mechanism, thereby allowing the hanger lid 52 to be secured in the closed position and assisting in retaining tire chains on the chain hanger assembly 40.

As will be appreciated, a pair of tire chain storage devices may be provided, for example mounted on respective left and right sides of a tractor or other vehicle. The tire chain storage device for mounting on the right side of the vehicle may have a chain hanger support member and chain hanger mounting bracket that respectively mirror the chain hanger support member 24 and chain hanger mounting bracket 26 of the tire chain storage device 20. In certain embodiments, the tire chain storage device 20 is designed to maximize interchangeability of components between left-side and right-side installations. In particular, components subject to impact or wear, such as elements of the lid assembly and the chain hanger hooks 42, may be configured to be interchangeable between left-hand and right-hand installations, thereby reducing part inventory requirements and facilitating repair and replacement. In other embodiments, one or more of the chain hanger support member 24 or chain hanger bracket 26 may be designed such that left and right installations share the same design of chain hanger support member or chain hanger bracket.

Chain hanger support member 24, hooks 42, or other parts of tire chain storage device 20 may also be configured to receive the fairing in order to store the fairing in an alternative position while using tire chains. For example, it may be desirable to store the fairing on the hooks if additional clearance is needed while operating the vehicle with chains.

One drawback of integrating a chain hanger with a fairing or mudflap hanger is that impacts to the mud flap, the fairing, or their hanger can transmit damaging forces to the chain hanger. Some embodiments may isolate these functions. Embodiments may include tire chain storage devices that are compatible with separate fairing or mud flap hangers. The tire chain storage device may be configured to mount a separate mud flap hanger or fairing support thereto. For example, the mud flap hanger can attach to the tire chain storage device using the same fasteners and frame locations as a conventional mud flap hanger. The tire chain storage device may include holes or slots aligned with mud flap hanger or fairing support arm mounting hardware. In certain embodiments, a mounting bracket of the tire chain storage device may be sandwiched between the vehicle frame rail and the mud flap hanger or fairing support, allowing retrofit installation without drilling new frame holes, simplified removal for off season storage, and compatibility with both spring loaded and rigid mud flap hangers and fairing support arms. In other embodiments, a mud flap hanger or fairing support arm may be configured to attach directly to another mounting location on the tire chain storage device. Some mounting brackets may incorporate slot-based mounting to allow the tire chain storage device to be slid into or out of position after partial loosening of existing bolts for an installed mud flap hanger or fairing hanger.

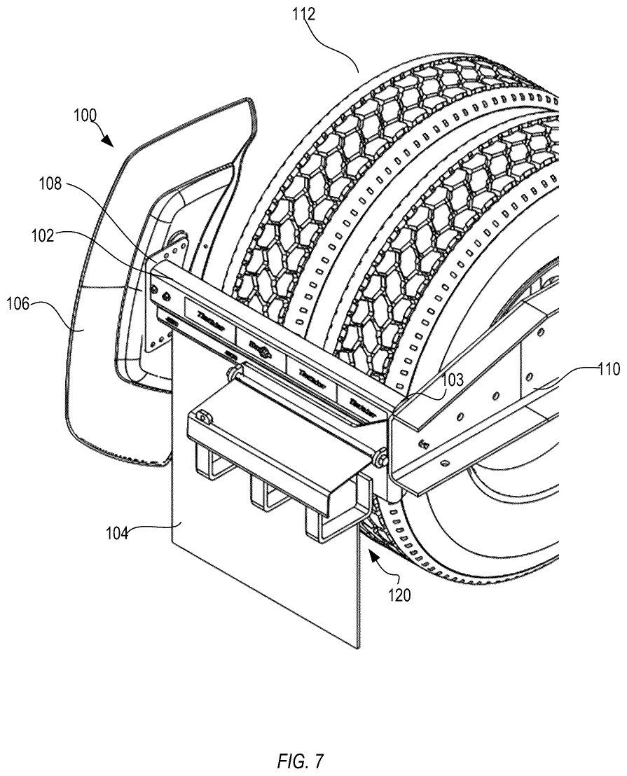

With reference to FIG. 7, one embodiment of a splash suppression system 100 and a tire chain storage device 120 mounted to a vehicle frame member 110, such as a frame rail of a tractor-trailer combination, is illustrated. In the illustrated embodiment, the splash suppression system 100 and the chain storage device 120 are mounted behind the rear drive wheels 112 of the tractor.

The splash suppression system 100 comprises a mud flap hanger 102 that supports a mud flap 104. In the embodiment shown, the mud flap hanger 102 is a straight-bar mud flap hanger; however, in other embodiments, the mud flap hanger 102 may be configured to support angled mud flaps, shortened mud flaps, or other splash suppression elements. The mud flap hanger 102 may be rigidly attached to the vehicle frame member 110 or may be a spring-loaded mud flap hanger. In some embodiments, the mud flap hanger 102 additionally functions as a fairing support arm to which an aerodynamic fairing 106 may be mounted. Non-limiting examples of fairing support arms that also function as mud flap hangers are described in U.S. Pat. No. 9,027,983, the entirety of which is incorporated by reference herein. In the illustrated embodiment, the aerodynamic fairing 106, which may be similar to aerodynamic fairing 70 in certain embodiments, is mounted to the mud flap hanger 102 using an adapter plate 108. In other embodiments, the tire chain storage device 120 may be used in conjunction with a fairing support that does not include a mud flap, or may be used independently of a mud flap hanger or fairing support.

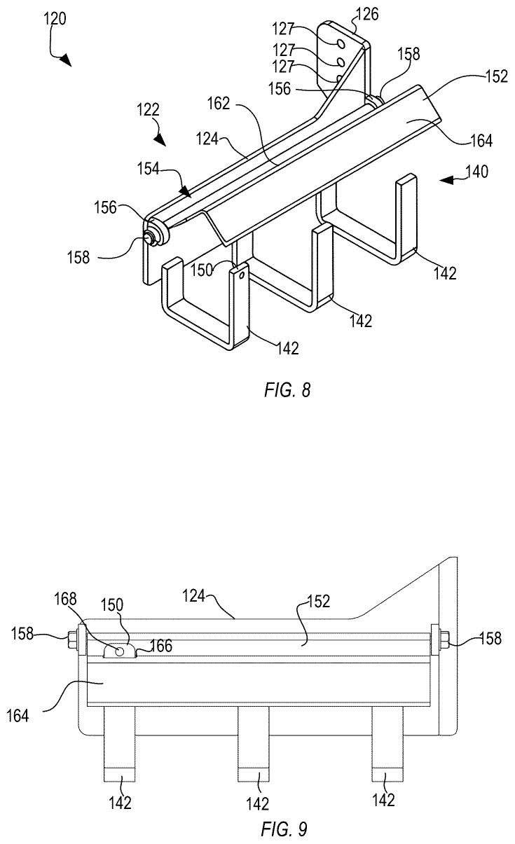

Referring to FIGS. 8-10, an elevational, a rear and a top view of one embodiment of the chain storage device 120 are provided. The tire chain storage device 120 includes a chain hanger support 122 configured for attachment to a vehicle frame member 110. In the illustrated embodiment, the chain hanger support 122 includes a chain hanger support member 124 and a chain hanger mounting bracket 126, the chain hanger mounting bracket 126 being configured to structurally support and secure the tire chain storage device 120 relative to the frame member 110. The chain hanger mounting bracket 126 and chain hanger support member 124 may be integrally formed from a plate of material or formed separately and welded, attached using hardware, or otherwise attached together.

As shown, the chain hanger mounting bracket 126 is arranged to extend generally longitudinally for attachment to an upright face the frame member 110. However, the chain hanger mounting bracket 126 is not limited to this configuration and may be formed in, or adapted to assume, a variety of alternative geometries, orientations, and mounting positions. By way of non-limiting example, the chain hanger mounting bracket 126 may be configured for attachment to an upper surface, lower surface, side surface, interior surface, or exterior surface of the frame member 110, and may further be configured for attachment to structural members adjacent to or supported by the vehicle frame. The chain hanger mounting bracket 126 may include generally planar, angled, L-shaped, U-shaped, multi-flanged, or contoured portions, and may be oriented horizontally, vertically, diagonally, or in a compound orientation relative to the frame member 110, depending on vehicle configuration, available mounting space, and installation requirements.

In a preferred embodiment, the chain hanger mounting bracket 126 provides an interface plate adapted to be sandwiched between the inboard end 103 of a support arm for another component, such as a mud flap or a fairing, and the frame member 110. For example, the chain hanger mounting bracket 126 may be sandwiched between the inboard end of the mud flap hanger 102 and the frame member 110. To this end, the chain hanger mounting bracket 126 includes one or more mounting apertures 127 configured to receive bolts, pins, studs, clamps, or other mounting hardware (not shown), thereby permitting the tire chain storage device 120 to be removably or permanently secured to the vehicle frame member 110 in a selected orientation. Preferably, the pattern of mounting apertures 127 is aligned with the mounting hardware for mounting the mud flap hanger 102 to the frame member so that the same hardware is used to mount both the mud flap hanger 102 and the chain storage device 120. In an even more particular embodiment, the pattern of mounting apertures 127 aligns with standard mud flap mounting hardware, such as vertically spaced bolts or mounting studs as is commonly used, though other patterns may be used. By aligning the mounting apertures with the mounting hardware of the mud flap or fairing hanger (e.g., mud flap hanger 102), a vehicle can be retrofitted with the tire chain storage device 120 without drilling new holes in the frame member 110. Further, the tire chain storage device 120 can be used with both spring-loaded and rigid mud flap and fairing hangers.

The chain storage device includes a tire chain hanger assembly 140 coupled to the chain hanger support member 124. In the illustrated embodiment, the chain hanger assembly 140 is mounted to an upright rear surface 138 of the chain hanger support member 124. In other embodiments, the chain hanger assembly or portions thereof may mount to or otherwise be supported by a front surface, an upper surface, a lower surface or other portion of the chain hanger support member 124. The chain hanger assembly 140 includes a plurality of spaced chain hanger hooks 142 configured to support and retain tire chains in a suspended condition. The chain hanger hooks 142 may be fixed in position, removable, rotatable, or foldable relative to the chain hanger support member 124, including configurations described in further embodiments herein. Each chain hanger hook 142 may include a shank, bend and return as discussed and may be a gusseted or otherwise reinforced hook. While three chain hanger hooks 142 are illustrated other embodiments may include more or fewer hooks.

In the illustrated embodiment of FIGS. 7-9, the chain hanger hooks are formed from bars having generally rectangular cross-sections with the shanks fixed to the chain hanger support member, such as through welding. Such hooks could be used in a chain hanger assembly integrated with a mud flap hanger or fairing hanger, such as chain hanger assembly 40 of FIGS. 1-7. Similarly, a separate chain storage device, such as chain storage device 120, may use chain hooks with circular cross-sections or other cross-sections as described in other embodiments.

One or more of the chain hanger hooks 142 may be formed with various cross-sectional geometries. In some embodiments, a chain hanger hook 142 is formed from a rod or bar having a generally circular cross-section, such as a bent steel rod. In other embodiments, the chain hanger hook 142 is formed from a rectangular, square, or other non-circular bar, which may be bent about one or more axes. In further embodiments, combinations of cross-sectional shapes may be used along different portions of the hook. In some embodiments, the chain hanger assembly 140 includes hooks having different configurations (e.g., different cross-sections, one or more hooks may be rotatable, while one or more hooks are fixed, etc.).

In some embodiments, one or more of the chain hanger hooks 142 includes a retention feature associated with the throat or tip region, such as a locking aperture, recess, notch, projection, or engagement surface configured to receive a pin, clip, strap, or other securing element to inhibit accidental chain dislodgement. In other embodiments, the hooks rely on gravitational retention and hook geometry alone to retain the chain.

One or more of the chain hanger hooks 142 may be formed as a unitary, one-piece component or as an assembly of multiple components, and may be fabricated from steel, alloy steel, stainless steel, forged metal, cast metal, or other materials suitable for supporting heavy tire chains and resisting deformation under impact loads.

The chain hanger assembly 140 includes a lid assembly comprising a hanger lid 152 operably coupled to the chain hanger support member 124 by a lid hinge 154. In the illustrated embodiment, the lid hinge 154 defines a generally horizontal axis of rotation about which the hanger lid 152 may pivot between an open position and a closed position. In one embodiment, the lid hinge 154 comprises a pair of clevis tabs 156 projecting from the chain hanger support member 124. Bolts 158, a hinge pin or other member(s) may traverse through the corresponding clevis tabs 156 to be received in corresponding openings formed in the hanger lid 152 to rotatably secure the hanger lid 152 to the chain hanger support member 124.

The hanger lid 152 may have a variety of form factors. In the illustrated embodiment, the hanger lid 152 includes an upper panel 162 and a distal panel 164 positioned distal from the hinge 154. In some embodiments, the distal panel 164 and extends below the tips of the chain hanger hooks 142 when the hanger lid 152 is closed, thereby partially enclosing the chain hanger hooks 142 and tire chains supported thereon.

The hanger lid 152 may include one or more hook access apertures through which a portion of a respective chain hanger hook 142 is exposed when the hanger lid 152 is in the closed position. Thus, one or more of the chain hanger hooks 142 may act as a lid looking hook. In the illustrated embodiment, the hanger lid 152 includes a hook access aperture 166 aligned with the outboard chain hanger hook 142. The tip 150 of this hook extends further up than the other chain hanger hooks 142 such that the outboard chain hanger hook 142 traverses through the hanger lid 152 leaving the tip region of the outboard chain hanger hook exposed when the hanger lid 152 is closed. The exposed tip region of the chain hanger hook 142 may include an aperture 168 or other feature configured to receive a pin, padlock, or other locking mechanism, thereby allowing the hanger lid 152 to be secured in the closed position and assisting in retaining tire chains on the chain hanger assembly 140.

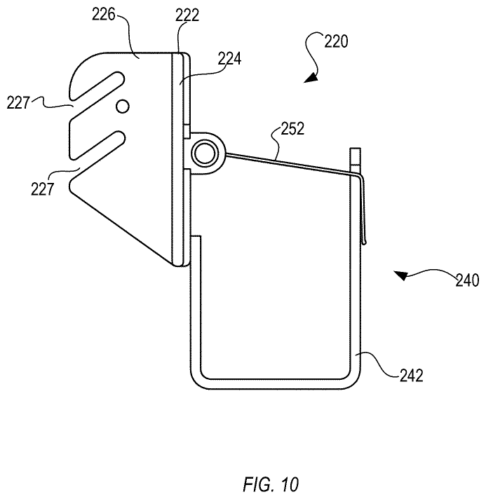

FIG. 10 is a diagrammatic representation of another embodiment of a chain storage device 220, shown from an outboard side. The chain storage device 220 comprises a chain hanger support 222 comprising a chain hanger support member 224 and a chain hanger mounting bracket. A chain hanger assembly is mounted to the chain hanger support member 224. Chain storage device 220 is generally similar to the chain storage device 120; however, the chain hanger mounting bracket 226 includes one or more mounting slots 227 that are open at one end, such as a forward end, to facilitate installation onto existing mounting hardware. In this configuration, where a mud flap hanger 102 is already mounted to the frame member 110, the mounting hardware securing the mud flap hanger 102 to the frame member 110 may be partially loosened, the chain storage device 220 slid into engagement with the loosened hardware via the open-ended mounting slots 227, and the mounting hardware subsequently retightened. In this manner, the chain storage device 220 may be installed without fully removing the existing mud flap hanger 102 from the vehicle.

As will be appreciated, a pair of tire chain storage devices according to the teachings of FIGS. 8-10 may be provided, for example mounted on respective left and right sides of a tractor or other vehicle. As will be appreciated some components may be interchangeable between left and right-side installations while others are mirrored. The tire chain storage device for mounting on the right side of the vehicle may have a chain hanger support that mirrors chain hanger support 122, 222 of the tire chain storage device 120, 220. Further, it may be preferable to have the locking mechanism for the hanger lid be on the outboard side for both left and right-side installations. In further embodiments, one or more of the chain hanger support member 124, 224 or chain hanger mounting bracket 126, 226 may be designed such that left and right installations share the same design of chain hanger support member or chain hanger bracket.

Embodiments of the chain hanger mounting brackets 126, 226 can allow conventional mudflap hangers (spring-loaded or otherwise) to mount with the tire chain storage device 120, 220 using the same means of attachment to the frame of the vehicle (e.g., common mudflap hangers have two bolts spaced 1.125″ or 2.5″ vertically apart). Other means of attaching a conventional mudflap hanger to the tire chain storage device may include providing separate mounting apertures on the tire chain storage device. The mounting apertures allow the bolts or studs of the mudflap hanger (or other support structure) to pass through, and once nuts are secured to the bolts or studs on the other side of the frame member both the mudflap hanger and the tire chain storage device 120, 220 are securely mounted to the vehicle. An advantage of using open-ended slots may be realized during installation in that the mudflap hanger can first be loosely secured to the vehicle, and the slots of the tire chain storage device 220 can be placed over the mudflap hanger studs or bolts, then the entire assembly secured. This tire chain storage device 220 may also be easily removed for storage during times of the year when tire chains are not needed or not required to be carried on the vehicle. The tire chain storage device 220 can be removed (with or without the chains secured to it) and stored without fully removing the mud flap hanger. One or more of the tire chain storage devices 120, 220 can be placed on a rack configured to receive the holes, slots, or other features of the hanger mounting bracket 126, 226 in order to reduce the amount of space required when stored. A further benefit of storing the entire device is that the tire chains may not need to be removed from the device, which can save considerable time and effort.

Chain hanger support member 124, 224, hooks 142, 242 or other parts of tire chain storage device 120, 220 may also be configured to receive the fairing in order to store the fairing in an alternative position while using tire chains. For example, it may be desirable to store the fairing on the hooks if additional clearance is needed while operating the vehicle with chains.

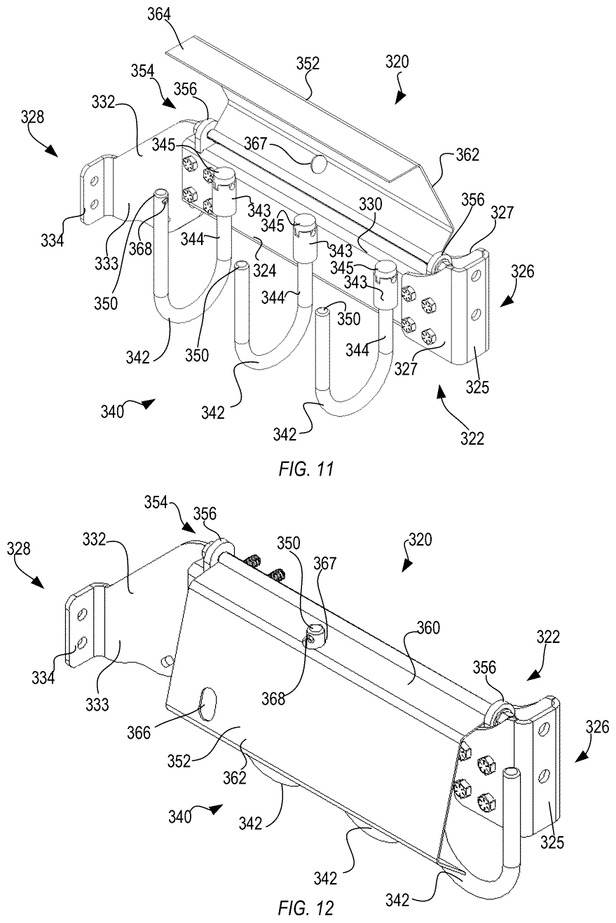

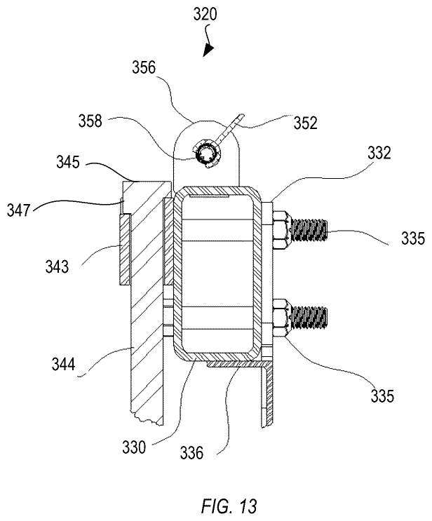

FIG. 11 is a diagrammatic representation of a modular chain storage device 320 having chain hanger hooks 342 in an extended (operational) position. FIG. 12 is a diagrammatic representation of one embodiment of the chain storage device 320 with the chain hanger hooks 342 in a folded up (stored) position. FIG. 13 is a diagrammatic representation of a cross-section of one embodiment of the chain storage device 320. FIG. 13 is a diagrammatic representation of an exploded view of the chain storage device 320 according to one embodiment.

The tire chain storage device 320 includes a chain hanger support assembly 322 configured for attachment to a vehicle frame member, such as a frame rail. In the illustrated embodiment, the chain hanger support assembly 322 includes a chain hanger support member 324 and a chain hanger mounting bracket 326, the chain hanger mounting bracket 326 being configured to structurally support and secure the tire chain storage device 320 relative to the vehicle frame member. In the illustrated embodiment, the chain hanger mounting bracket 326 is separable from the chain hanger support member 324 and is configured for use in both left-side and right-side installations. The bracket may thus be universally mountable on either a longitudinal driver-side frame rail or a longitudinal passenger-side frame rail. Even more specifically, the bracket 326 may be symmetrically configured such that its geometry is orientation-independent relative to the vertical transverse plane of the vehicle.

In other embodiments, the chain hanger mounting bracket 326 may be formed integrally with, or permanently coupled to, the chain hanger support member 324. In further embodiments, the chain hanger mounting bracket may be specific to a left-side or a right-side installation.

In one embodiment, such as that illustrated in FIG. 13, the chain hanger mounting bracket 326 includes a double-shear configuration and comprises a frame interface plate 325 adapted to be positioned adjacent the frame member. The frame interface plate 325 includes one or more mounting apertures configured to receive bolts, pins, studs, clamps, or other fastening hardware (not shown), thereby permitting the tire chain storage device 320 to be removably or permanently secured to the vehicle frame member in a selected orientation. A pair of spaced plates 327 extend from the frame interface plate 325 and are configured to receive an inboard end of the chain hanger support member 324 therebetween. Apertures formed through the plates 327 may align with corresponding apertures in the chain hanger support member 324 to receive mounting hardware, such as pins or bolts, allowing the chain hanger support member 324 to be removably secured to the chain hanger mounting bracket 326.

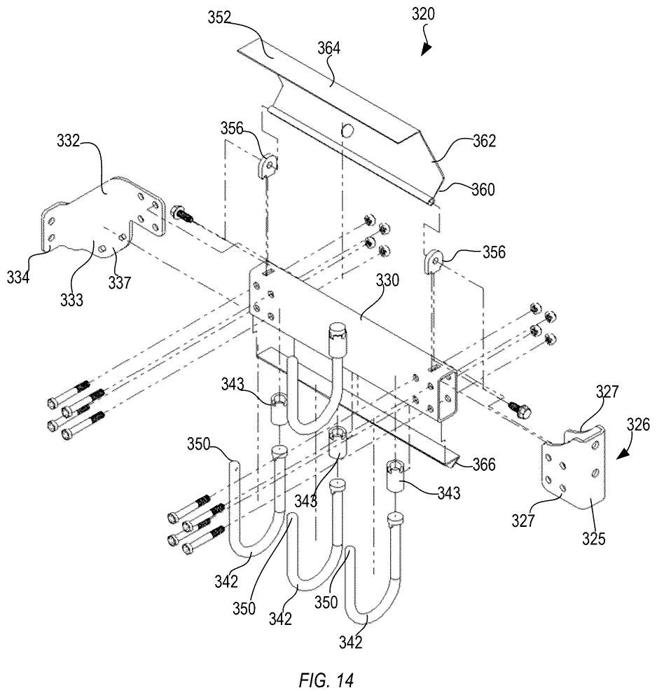

While in one embodiment, as illustrated in FIGS. 11-14, the chain hanger mounting bracket 326 includes a double-shear structure having spaced plates 327 that receive the inboard end of the chain hanger support member 324, the chain hanger mounting bracket 326 may have other form factors. For example, the chain hanger mounting bracket 326 may form a socket configured to receive the inboard end of the chain hanger support member 324. In some embodiments, the inboard end of the chain hanger support member 324 is removably attached to the chain hanger mounting bracket 326 without tools, such as through the use of telescoping tubing and snap pins. In further embodiments, the tire chain storage device 320 may incorporate a spring-biasing mechanism that permits controlled deflection between a support arm and a base or vehicle structure, for example as described in U.S. Pat. No. 9,027,983, entitled “Aerodynamic System and Adjustable Fairings,” filed Nov. 1, 2013, the entirety of which is incorporated by reference herein, to allow the chain hanger support member 324 to deflect relative to the frame member.

In the illustrated embodiment, the chain hanger mounting bracket 326 is arranged for attachment to an upright face of the frame member. However, the chain hanger mounting bracket 326 is not limited to this configuration and may be formed in, or adapted to assume, a variety of alternative geometries, orientations, and mounting positions. By way of non-limiting example, the chain hanger mounting bracket 326 may be configured for attachment to an upper surface, lower surface, side surface, interior surface, or exterior surface of the frame member, and may further be configured for attachment to structural members adjacent to or supported by the vehicle frame. The chain hanger mounting bracket 326 may include generally planar, angled, L-shaped, U-shaped, multi-flanged, or contoured portions, and may be oriented horizontally, vertically, diagonally, or in a compound orientation relative to the frame member, depending on vehicle configuration, available mounting space, and installation requirements.

The chain hanger support member 324 is coupled to the chain hanger mounting bracket 326 at a first end and extends generally laterally to a second end 328 configured for mounting an aerodynamic fairing, such as aerodynamic fairing 70 or other rear fairing, a quarter fairing or other fairing. The chain hanger support member 324 may have a variety of form factors and may, for example, comprise a plate, an L-beam, a tube with a rectangular, circular, or other tubular cross-section, or a generally U-shaped or otherwise contoured profile. In some embodiments, the chain hanger support member may comprise a telescoping arm.

In the illustrated embodiment, the chain hanger support member 324 includes a first support member—a chain hanger frame 330—and an extension bracket. The type of extension bracket may depend on whether the operator will use a fairing in conjunction with the tire chain storage device 320, the type of fairing (if any), and the type of mud flap (if any). In the embodiment illustrated, the extension bracket is a chain hanger fairing bracket 332 adapted for supporting a fairing. The chain hanger frame 330 forms a first leg that extends generally laterally, in a generally horizontal direction from the chain hanger mounting bracket 326. In other embodiments, the chain hanger frame 330 may be otherwise angled relative to the vehicle frame. The chain hanger fairing bracket 332 forms a second leg that extends generally laterally out and down chain hanger frame 330 at a selected angle, such as approximately forty-five degrees or another suitable angle. In other embodiments, the chain hanger support member 324 may be substantially straight, curved, or follow other paths suitable for the intended mounting location and vehicle configuration. In some embodiments, the chain hanger support member 324 may comprise multiple components and may, for example, comprise a telescoping arm.

Preferably, the chain hanger frame 330 is separable from the chain hanger mounting bracket 326 and the chain hanger fairing bracket 332 and is suitable for right-side and left-side installation. The chain hanger frame 330 may thus be universally mountable on either a longitudinal driver-side frame rail or a longitudinal passenger-side frame rail. Even more specifically, the chain hanger frame 330 may be symmetrically configured such that its geometry is orientation-independent relative to the vertical transverse plane of the vehicle.

In one example embodiment, the chain hanger frame 330 is formed from a rectangular tube and includes mounting apertures at an inboard end portion configured to facilitate attachment to the chain hanger mounting bracket 326. An outboard end portion of the chain hanger frame 330 includes mounting apertures configured to receive mounting hardware for securing the chain hanger fairing bracket 332. The chain hanger fairing bracket 332 includes a portion 333 extending generally laterally out and down from the chain hanger frame to a fairing mounting interface 334. The inboard end portion of the chain hanger fairing bracket 332 includes mounting apertures that align with corresponding apertures at the outboard end portion of the chain hanger frame for accommodating mounting hardware 335 for mounting the fairing mounting bracket 332 to the chain hanger frame 330.

In some embodiments, the fairing mounting interface 334 comprises an outboard plate having one or more mounting apertures formed therethrough for mounting an aerodynamic fairing. In certain embodiments, the mounting apertures formed in the fairing may not align with the mounting apertures of the fairing mounting interface 334. Accordingly, an adapter may be used, as discussed above with respect to fairing 70. The adapter may allow for multiple mounting positions or orientations. Further, embodiments of the fairing mounting bracket 332 may support various means for mounting the fairing. Bracket 332, hooks 342, or other parts of tire chain storage device 320 may also be configured to receive the fairing in order to store the fairing in an alternative position while using tire chains. For example, it may be desirable to store the fairing on the hooks if additional clearance is needed between the wheels and the fairing while operating the vehicle with chains.

The outward position of the fairing may be controlled by selecting the chain hanger frame 330 or the fairing mounting bracket 332 to use to achieve a desired position, adjusting the length of an adjustable length arm (e.g., an adjustable chain hanger support member 324), offsetting the chain hanger support member 324 from the frame member, selecting the thickness of the fairing to ensure proper positioning and configuration of the fairing, selecting the adapter or position of the adapter, or otherwise controlling the position of the fairing.

In some embodiments, the chain hanger support member 324 may act as a mud flap hanger. To this end, a mud flap flange 336 is provided that is attached to and extends down from the chain hanger frame 330. The mud flap flange 336 can include mud flap mounting apertures for accommodating mounting hardware for mounting a mudflap. Similarly, the chain hanger fairing bracket 332, and particularly the portion 333, may include a mud flap support area 337 support area for hanging a mudflap. The mud flap support area may include mud flap mounting apertures. In the illustrated embodiment, the chain hanger support member 324 forms an angled mud flap hanger for an angled mud flap (sometimes referred to as 45-degree mud flap, though the mud flap corner may have other angles). In other embodiments, the chain hanger support member 324 may be straight or otherwise shaped to accommodate non-angled (straight bar) mud flaps, shortened mud flaps, or other splash suppression elements.

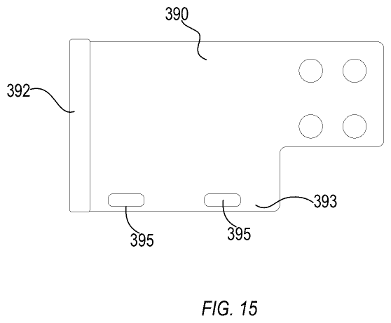

As discussed, various extension brackets may be attached to the chain hanger frame 330. For example, if the operator is going to use a standard mud flap with and a fairing, they may use an alternative chain hanger fairing bracket 390 having a fairing mounting interface 392 similar to fairing mounting interface 334 (or another fairing mounting interfaces), but having a mud flap support area 393 with horizontal row of mud flap mounting apertures 395 that horizontally align with the apertures of mud flap flange 336 (FIG. 15). If the operator is not going to use a fairing, the operator may select an extension bracket similar to the chain hanger fairing bracket 332 or the chain hanger fairing bracket 390, but without the respective fairing mounting interface 334, 392, depending on the style of mud flap to be used. Other extension brackets may also be supported. Further different sizes of extension brackets may be offered to adjust the position of the fairing. In further embodiments, extension brackets may be mountable in multiple positions to allow adjustment of the fairing's position or otherwise control the overall width of the tire chain storage device 320. Further, in some embodiments, the operator may decide not to install an extension bracket.

While in the illustrated embodiment, the extension bracket (e.g., chain hanger fairing bracket 332) is rigidly connected to the chain hanger frame 330, other embodiments may incorporate a hinge or other articulating mechanism. One example embodiment of a hinged chain hanger fairing bracket is discussed below.

The tire chain storage device 320 includes a tire chain hanger assembly 340 coupled to the chain hanger support member 324. In the illustrated embodiment, the chain hanger assembly 340 is mounted to the chain hanger frame 330. The chain hanger assembly 340 or portions thereof may mount to or otherwise be supported by a front surface, a rear surface, an upper surface, a lower surface or other portion of the chain hanger support member 324. The chain hanger assembly 340 includes a plurality of spaced chain hanger hooks 342 configured to support and retain tire chains in a suspended condition. While three chain hanger hooks 342 are illustrated other embodiments may include more or fewer hooks. Chain hanger hooks 342 may be fixed in position, removable, rotatable, or foldable relative to the chain hanger support member 324, depending on the embodiment.

One or more of the chain hanger hooks 342 may be formed with various cross-sectional geometries. In some embodiments, a chain hanger hook 342 is formed from a rod or bar having a generally circular cross-section, such as a bent steel rod. In other embodiments, the chain hanger hook 342 is formed from a rectangular, square, or other non-circular bar, which may be bent about one or more axes to form the shank, bend, and return portion. In further embodiments, combinations of cross-sectional shapes may be used along different portions of the hook. In some embodiments, the chain hanger assembly 340 includes hooks having different configurations (e.g., different cross-sections, one or more hooks may be rotatable, while one or more hooks are fixed, etc.).

In some embodiments, one or more chain hanger hooks 342 includes a retention feature associated with the throat or tip region, such as a locking aperture, recess, notch, projection, or engagement surface configured to receive a pin, clip, strap, or other securing element to inhibit accidental chain dislodgement. In other embodiments, the hooks rely on gravitational retention and hook geometry alone to retain the chain.

One or more of the chain hanger hooks 342 may be formed as a unitary, one-piece component or as an assembly of multiple components, and may be fabricated from steel, alloy steel, stainless steel, forged metal, cast metal, or other materials suitable for supporting heavy tire chains and resisting deformation under impact loads.

In certain embodiments, the chain hanger assembly 340 includes a plurality of chain hanger hook collars 343 mounted to the chain hanger support member 324, each hook collar 343 being configured to receive and support a shank 344 of a respective chain hanger hook 342. In such embodiments, the shank 344 extends at least partially through the corresponding hook collar 343, such that the hanger hook 342 is supported in a suspended arrangement relative to the chain hanger support member 324. An upper end portion of the shank 344 may include a retaining head 345 configured to inhibit downward withdrawal of the shank 344 through the hook collar 343. The retaining head 345 may be formed integrally with the shank 344 or may be provided as a separate retaining member coupled to the shank 344, such as by threaded engagement, press-fit, welding, or other attachment means. In certain embodiments, the hanger hook 342 is removably retained within the hook collar 343, allowing individual hanger hooks 342 to be replaced, removed for seasonal use, or interchanged between left-hand and right-hand installations.

In certain embodiments, a chain hanger hook 342 and its corresponding hook collar 343 are configured to allow controlled angular movement of the hanger hook 342 relative to the chain hanger support member 324, including rotatable or foldable movement, while inhibiting free swinging during vehicle operation. In more particular embodiments, the hanger hook 342 and hook collar 343 together define a clocking interface or multi-position indexing arrangement that permits selective repositioning of the hanger hook 342 between two or more discrete positions, including an extended, chain-supporting position and a folded or retracted position. For example, in one embodiment, the shank 344 includes an indexing feature such as a non-circular cross-section (by way of example, square, hexagonal, or other polygonal geometry) that engages a correspondingly shaped bore in the hook collar 343 to define a plurality of discrete angular positions.

In other embodiments, the shank 344 or the hook collar 343 includes grooves, splines, teeth, or similar features that cooperate to provide indexed rotational positioning, including finer incremental adjustment. In still another embodiment, such as that illustrated in FIG. 22, the hook collar 343 comprises a notched or castellated collar having a plurality of notches 346 formed therein, and the chain hanger hook 342 includes a pin, tab, projection, or other key 347 configured to selectively engage the notches 346. In some embodiments, the retaining head 345 functions as an indexing head and includes a key or projection on an underside thereof that is received within a selected notch 346. In these configurations, the hanger hook 342 may be repositioned via a lift-and-turn mechanism, wherein an operator lifts the hanger hook 342 upward to disengage the key 347 from a notch 346, rotates the hanger hook 342 to a new angular or folded position, and then allows the hanger hook 342 to move downwardly so that the key 347 engages a corresponding notch 346. In some embodiments, the hook-and-collar arrangement further includes a spring-biased indexing mechanism, such that the hanger hook 342 is biased toward a locked position and must be lifted against a spring force to permit rotation or folding, with the spring subsequently biasing the hanger hook 342 back into a defined, locked position. Accordingly, the hook collar 343 may support fixed, removable, rotatable, foldable, or indexed chain hanger hooks 342.

The chain hanger assembly 340 includes a lid assembly comprising a hanger lid 352 operably coupled to the chain hanger support member 324 by a lid hinge 354. In the illustrated embodiment, the lid hinge 354 defines a generally horizontal axis of rotation about which the hanger lid 352 is pivotable between an open position and a closed position. In one embodiment, the lid hinge 354 comprises a pair of clevis tabs 356 projecting from the chain hanger support member 324. One or more fasteners, such as bolts 358, a hinge pin, or other suitable hinge members, may extend through aligned openings in the clevis tabs 356 and corresponding openings formed in the hanger lid 352 to rotatably secure the hanger lid 352 to the chain hanger support member 324.

The hanger lid 352 may assume a variety of form factors. In the illustrated embodiment, the hanger lid 352 includes an upper panel 362, a distal panel 364 positioned distally from the lid hinge 354, and a proximal panel 360 positioned proximate to the lid hinge 354. When the hanger lid 352 is in the closed position, the distal panel 364 may extend downwardly from the upper panel 362. In some embodiments, the distal panel 364 extends below one or more tips 350 of the chain hanger hooks 342 when the hanger lid 352 is closed, thereby partially enclosing the chain hanger hooks 342 and tire chains supported thereon.

In certain embodiments, one or more of the chain hanger hooks 342 may function as a lid-locking hook. In the illustrated embodiment, for example, a return portion of an outboard chain hanger hook 342 extends upward relative to other chain hanger hooks 342. Correspondingly, the hanger lid 352 may include one or more hook access apertures through which a portion of the lid-locking hook is exposed when the hanger lid 352 is in the closed position. In the illustrated embodiment, the hanger lid 352 includes a first hook access aperture 366 aligned to permit a tip region of the lid-locking hook to project therethrough when the hook is in an extended, chain-supporting position (e.g., FIG. 11), and a second hook access aperture 367 aligned to permit the tip region of the lid-locking hook to project therethrough when the hook is in a folded or stored position (e.g., FIG. 12). The exposed tip region of the chain hanger hook 342 may include an aperture 368 or other feature configured to receive a pin, padlock, or other securing element, thereby allowing the hanger lid 352 to be secured in the closed position, assisting in retaining tire chains on the chain hanger assembly 340, and protecting the chain hanger hooks 342 when not in use.

As will be appreciated, a pair of tire chain storage devices may be provided, for example mounted on respective left and right sides of a tractor or other vehicle. In certain embodiments, the tire chain storage device 320 is designed to maximize interchangeability of components between left-side and right-side installations. For example, the tire chain storage device for mounting on the right side of the vehicle may have a chain hanger frame 330 and chain hanger mounting bracket 326 that are the same as those for mounting on the right side. Further, components such as chain hanger hooks 342 may be configured to be interchangeable between left-hand and right-hand installations, thereby reducing part inventory requirements and facilitating repair and replacement.

In some embodiments, a modular support member, such as chain hanger frame 330, may be incorporated in a tire chain storage device configured to mount a separate mud flap hanger or fairing support arm thereto. For instance, bracket 326 may include an interface plate with apertures matching the mounting hardware pattern for a mud flap hanger or fairing support arm so that the mud flap hanger or fairing support arm can attach to the tire chain storage device. In other embodiments, a mud flap hanger or fairing support arm may be configured to attach directly to another mounting location on the tire chain storage device.

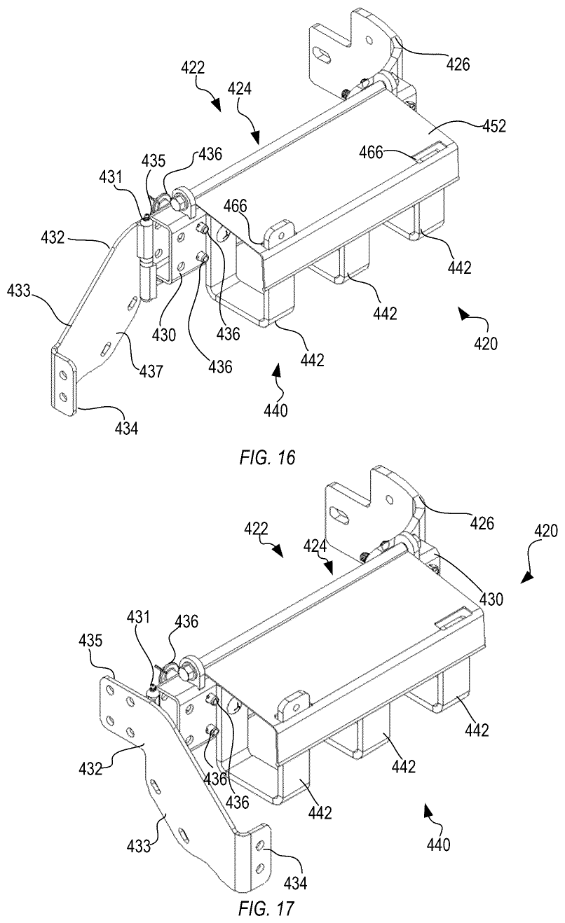

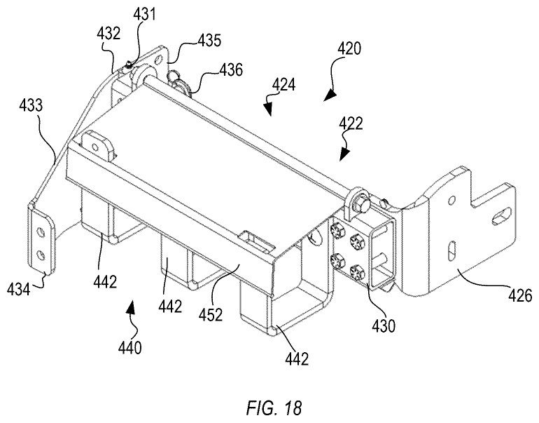

With reference to FIGS. 16-18, another embodiment of a tire chain storage device 420 is illustrated. The tire chain storage device 420 includes a chain hanger support assembly 422 configured for attachment to a vehicle frame member, such as a frame rail. In the illustrated embodiment, the chain hanger support assembly 422 includes a chain hanger support member 424 and a chain hanger mounting bracket 426, the chain hanger mounting bracket 426 being configured to structurally support and secure the tire chain storage device 420 relative to the vehicle frame member. In the illustrated embodiment, the chain hanger mounting bracket 426 is separable from the chain hanger support member 424. In other embodiments, the chain hanger mounting bracket 426 may be formed integrally with, or permanently coupled to, the chain hanger support member 424. Other mounting bracket configurations may also be used, including, by way of non-limiting example, the chain hanger mounting bracket 326 and other mounting brackets described in connection with the tire chain storage device 320. The chain hanger mounting bracket 426 may, in some embodiments, adapted to be sandwiched between the inboard end of a support arm for another component, such as a mud flap or a fairing, and the frame member. According to one embodiment, the mounting bracket 426 includes a pattern of mounting apertures that aligns with standard mud flap mounting hardware, such as vertically spaced bolts or mounting studs as is commonly used, though other patterns may be used. In some embodiments, the apertures include slots that are open to allow the chain storage device to be installed/removed without fully uninstalling the mad flap hanger or fairing support arm.

The chain hanger support member 424 is coupled to the chain hanger mounting bracket 426 at a first end. In the illustrated embodiment, the chain hanger support member 424 includes a first support member—a chain hanger frame 430—and an extension bracket. The chain hanger frame 430 may be similar to the chain hanger frame 330 described above. The type and configuration of the extension bracket may depend on whether an aerodynamic fairing is used in conjunction with the tire chain storage device 420, the type of fairing to be supported, and the type of mud flap, if any. In the illustrated embodiment, the extension bracket comprises a chain hanger fairing bracket 432 adapted to support an aerodynamic fairing. The chain hanger fairing bracket 432 is coupled to the chain hanger frame 430 by a hinge 431 or other rotatable joint, such that the hanger fairing bracket 432 is pivotable relative to the chain hanger frame 430. The chain hanger fairing bracket 432 includes a first portion 433 extending from the hinge 431 to a distal end that includes a fairing mounting interface 434, and a second portion 435 extending in an opposite direction from the hinge 431 and forming a heel portion. An aerodynamic fairing, such as fairing 70, a rear fairing, a quarter fairing, or another suitable fairing, may be mounted to the fairing mounting interface 434. In certain embodiments, mounting apertures formed in the fairing may not align with apertures of the fairing mounting interface 434, in which case an adapter may be used, such as those described above with respect to fairing 70. The adapter may permit multiple mounting positions or orientations of the fairing. Further, embodiments of the chain hanger fairing bracket 432 may support various means for mounting an aerodynamic fairing.

In a primary position, with the chain hanger fairing bracket 432 extended outwardly, one or more apertures formed in the heel portion 435 may align with corresponding apertures formed in the chain hanger frame 430. Fastening hardware, such as bolts, spring-loaded pins 436, or other releasable locking mechanisms, may be inserted through the aligned apertures to releasably secure the chain hanger fairing bracket 432 in the primary orientation. The primary orientation of the chain hanger fairing bracket 432 may correspond to a primary or aerodynamic operating position of the fairing. When desired, the locking mechanism may be disengaged, allowing the chain hanger fairing bracket 432 to pivot about the hinge 431 to move the fairing into a secondary position. As will be appreciated, various sizes, shapes, and configurations of rotatable extension brackets may be provided to adjust the position of the fairing or to accommodate different styles of fairings or mud flaps. For example, the chain hanger fairing bracket 432 may have a mud flap support area 437 with mounting apertures configured for use with an angled mud flap, while another rotatable fairing bracket, such as a hinge-mounted bracket similar to chain hanger fairing bracket 390, may be configured for use with a straight or standard mud flap.

The tire chain storage device 420 further includes a chain hanger assembly 440 coupled to the chain hanger support member 424. In the illustrated embodiment, the chain hanger assembly 440 is mounted to the chain hanger frame 430. The chain hanger assembly 440, or portions thereof, may be mounted to or otherwise supported by a front surface, rear surface, upper surface, lower surface, or other portion of the chain hanger support member 424. The chain hanger assembly 440 includes a plurality of spaced chain hanger hooks 442 configured to support and retain tire chains in a suspended condition. Although three chain hanger hooks 442 are illustrated, other embodiments may include more or fewer hooks. In the illustrated embodiment, the chain hanger hooks 442 are secured to the chain hanger frame 430 using fasteners, such as bolts. In certain embodiments, the chain hanger hooks 442 are removable, allowing an operator to remove the hooks when not in use to reduce weight or increase clearance.

The illustrated embodiment further includes a hanger lid 452 that may be used on either a left-side installation or right-side installation. For example, the hanger lid 452 includes hook access apertures hook access apertures 466 through which an outboard lid locking hook can pass regardless of whether the hanger lid is used for a right-side installation or left side installation.

As discussed, it may be desirable to store the fairing on the tire chain hanger device if additional clearance is needed while operating the vehicle with chains. In some embodiments, the bracket 432 can be releasably locked in the secondary position to store the fairing in the secondary position. Further, the chain hanger support member 424, the hooks 442 or other parts of tire chain storage device 420 may be configured to receive the fairing in order to store the fairing in an alternative position while using the tire chains.

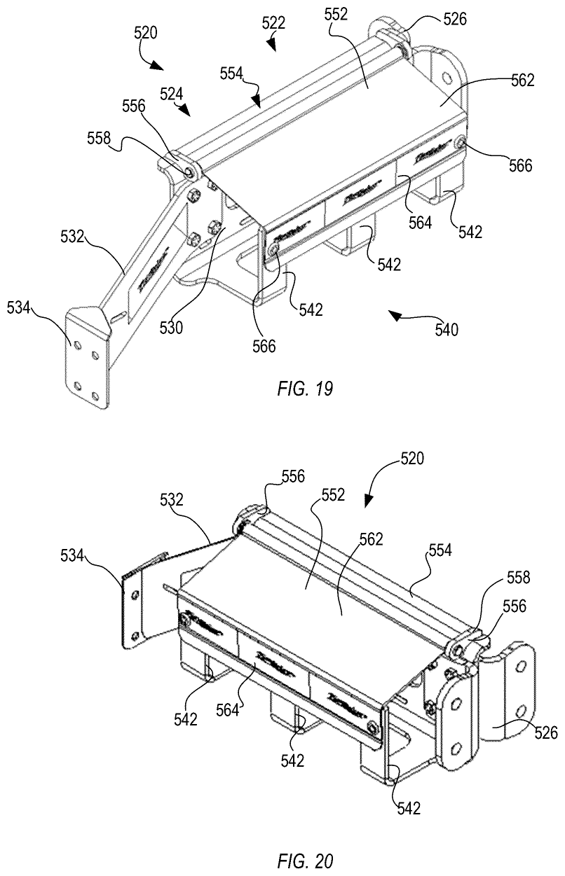

With reference to FIGS. 19-20, another embodiment of a tire chain storage device 520 is illustrated. The tire chain storage device 520 includes a chain hanger support assembly 522 configured for attachment to a vehicle frame member, such as a frame rail. In the illustrated embodiment, the chain hanger support assembly 522 includes a chain hanger support member 524 and a chain hanger mounting bracket 526, the chain hanger mounting bracket 526 being configured to structurally support and secure the tire chain storage device 520 relative to the vehicle frame member. In the illustrated embodiment, the chain hanger mounting bracket 526 is separable from the chain hanger support member 524. In other embodiments, the chain hanger mounting bracket 526 may be formed integrally with, or permanently coupled to, the chain hanger support member 524. Other mounting bracket configurations may also be used, including, by way of non-limiting example, the chain hanger mounting bracket 526 and other mounting brackets described in connection with the tire chain storage device 520.

The chain hanger support member 524 is coupled to the chain hanger mounting bracket 526 at a first end. In the illustrated embodiment, the chain hanger support member 524 includes a first support member 530 and an extension bracket 532. In the illustrated embodiment, the first support member 530 and the chain hanger hooks 542 are integrally formed from a plate of sheet metal. In the illustrated embodiment, the extension bracket 532 is a chain hanger fairing bracket that includes a fairing mounting interface 534. An aerodynamic fairing, such as fairing 70, a rear fairing, a quarter fairing, or another suitable fairing, may be mounted to the fairing mounting interface 534. In certain embodiments, mounting apertures formed in the fairing may not align with apertures of the fairing mounting interface 534, in which case an adapter may be used, such as those described above with respect to fairing 70. The adapter may permit multiple mounting positions or orientations of the fairing. Further, embodiments of the extension bracket 532 may support various means for mounting an aerodynamic fairing. In some embodiments, the first support member 530 or the extension bracket 532 includes multiple apertures so that the position of the extension bracket 532 can be adjusted to thereby set the position of the fairing.

The chain hanger assembly 540 includes a plurality of spaced chain hanger hooks 542 configured to support and retain tire chains in a suspended condition. Although three chain hanger hooks 542 are illustrated, other embodiments may include more or fewer hooks. In the illustrated embodiments, the chain hanger hooks 542 and the first support member 530 may be formed from a plate of sheet metal.

The chain hanger assembly 540 may further comprise a lid assembly comprising a hanger lid 552 rotatably coupled to the first support member by a lid hinge 554. In one embodiment, the lid hinge 554 comprises a pair of clevis tabs 556 integrally formed with the first support member 530. One or more fasteners, such as bolts 558, a hinge pin, or other suitable hinge members, may extend through aligned openings in the clevis tabs 556 and corresponding openings formed in the hanger lid 552 to rotatably secure the hanger lid 552 to the chain hanger support member 524. The hanger lid 552 may assume a variety of form factors. In the illustrated embodiment, the hanger lid 552 includes an upper panel 562 and a distal panel 564 positioned distally from the lid hinge 554. When the hanger lid 552 is in the closed position, the distal panel 564 may extend downwardly from the upper panel 562. In some embodiments, the distal panel 564 extends below one or more tips of the chain hanger hooks 542 when the hanger lid 552 is closed, thereby partially enclosing the chain hanger hooks 542 and tire chains supported thereon. In the embodiment illustrated in FIG. 19 and FIG. 20, the lid locking hook does not project through the hanger lid. Instead, the distal panel 564 may include lid lock apertures 566 that align with apertures through one or more lid locking hooks. Thus, a locking feature, such as a pin, padlock, or other securing element, thereby allowing the hanger lid 552 to be secured in the closed position.

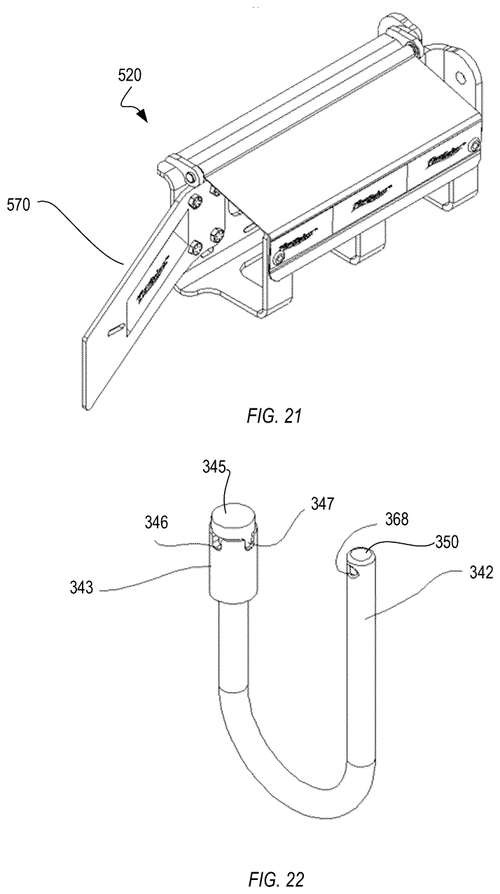

The type and configuration of the extension bracket used may depend on whether an aerodynamic fairing is used in conjunction with the tire chain storage device 520, the type of fairing to be supported, and the type of mud flap, if any. Thus, as illustrated in FIG. 21, a different extension bracket 570 may be used. As will be appreciated, various sizes, shapes, and configurations of extension brackets may be provided to adjust the position of the fairing or to accommodate different styles of fairings or mud flaps.

As discussed, it may be desirable to store the fairing on the tire chain hanger device if additional clearance is needed while operating the vehicle with chains. In some embodiments, the bracket 532, hooks 545 or other parts of the tire chain storage device 520 may be configured to receive the fairing in order to store the fairing in an alternative position while using the tire chains.

One advantage of certain embodiments of the tire chain storage device, such as the chain storage devices 320, 420, and 520, is that the corresponding chain hanger mounting bracket 326, 426, or 526 may remain installed on the vehicle frame member while the associated chain hanger frame 330, chain hanger frame 430, or first support member 530 is removably detached. In such embodiments, the chain hanger frame may be removed as a unit with the chain hanger hooks attached and, in some cases, with the tire chains remaining supported on the hooks. The removed chain hanger frame may be mounted to a storage rack, shelf, or similar structure in a warehouse, garage, or other storage location and used to store the tire chains during an off-season or when the chains are not required on the vehicle. In other embodiments, the chain hanger hooks are supported on a removable cross-bar or hook support member, such that the bar and hooks may be removed from the tire chain storage device as a unit for storage together with the tire chains.

As discussed, various embodiments may include a hanger lid. In some embodiments, the hanger lid 52, 152, 252, 352, 452, 552 is removably coupled to the chain hanger support member 24, 124, 224, 324, 424, 524. For example, one or more quick-release pins, or captive fasteners may be used to couple the hanger lid to the respective clevis tabs or other structure to permit the hanger lid 52, 152, 252, 352, 452, 552 to be detached from the chain hanger support member without tools. In other embodiments, the lid assembly includes one or more quick-release retention features, such as spring-biased pins, detents, latches, cams, over-center clamps, or keyed fasteners, that allow the hanger lid 52, 152, 252, 352, 452, 552 to be quickly installed or removed for servicing, seasonal removal, or chain installation. In certain embodiments, the hanger lid 52, 152, 252, 352, 452, 552 may be completely removable and stored separately from the chain hanger assembly 40, 140, 240, 340, 440, 540 when not required.

In further embodiments, the lid assembly may include a combination of hinged and removable configurations, such that the hanger lid 52, 152, 252, 352, 452, 552 is pivotable between open and closed positions during normal use and further removable from the chain hanger support member when placed in a release position. The lid assembly may additionally include retention features configured to secure the hanger lid 52, 152, 252, 352, 452, 552 in an open position during chain installation or removal. The removable or quick-release features may be provided on one side, both sides, or along a hinge axis of the hanger lid 52, 152, 252, 352, 452, 552.

Further the hanger lid 52, 152, 252, 352, 452, 552 may be formed from metal (e.g., aluminum, steel or other metal), polymer, composite, or other suitable material. Preferably, the hanger lid 52, 152, 252, 352, 452, 552 is formed from lightweight, corrosion-resistant, or aerodynamic materials. The hanger lid 52, 152, 252, 352, 452, 552 may have an airfoil shape or other aerodynamic shape to improve airflow compared to conventional flat box lids.

As discussed, FIG. 22 illustrates one embodiment of a rotatable chain hanger hook 342. Such hooks may be used in chain storage devices that include integrated fairings or mudflaps (e.g., similar to chain storage device 20), chain storage devices that mount in conjunction with separate mud flap or fairing hangers or other chain storage devices.

Embodiments of the tire chain storage device may incorporate any suitable chain hanger hooks. FIG. 23 illustrates another embodiment of a chain hanger hook 600 configured to pivot or fold between an operational position for supporting a tire chain and a folded or storage position. If the chain hanger hook 600 is a lid locking hook, the tip region of the chain hanger hook 600 may include an aperture or other feature configured to receive a pin, padlock, or other securing element.

In certain embodiments, a chain hanger assembly includes one or more chain hanger hook collars 602 mounted to a chain hanger support member, each hook collar 602 being configured to receive and support a shank 644 of a respective chain hanger hook 600. In such embodiments, the shank 644 extends at least partially through the corresponding hook collar 602. An upper end portion of the shank 644 may include a plurality of locking pin apertures, such as apertures 606 and 608, that are angularly offset relative to one another and may additionally be positioned at different axial locations along the shank 644. The hook collar 602 likewise includes one or more locking pin apertures 610 formed therethrough.

In the illustrated embodiment, the hook collar 602 further includes a locking pin mechanism comprising a lock pin body 612 and a lock pin spring retainer 614 configured to house and retain a biasing spring that urges a lock pin 616 toward a locked position. An operator may actuate a lock pin knob 618 to retract the lock pin 616 against the spring bias. When one of the locking pin apertures 606 or 608 of the chain hanger hook 600 is aligned with a corresponding locking pin aperture 610 of the hook collar 602, the lock pin 616 may extend through the aligned apertures to secure the hanger hook 600 in a selected angular position. In this manner, the operator may reposition the hanger hook 600 by lifting and rotating, or rotating and lowering, the hanger hook 600 to move between operational, folded, or other indexed positions. In some embodiments, the hanger hook 600 may be fully removable from the hook collar 602, for example to reduce weight, increase clearance, or when the tire chain storage device is not in use.

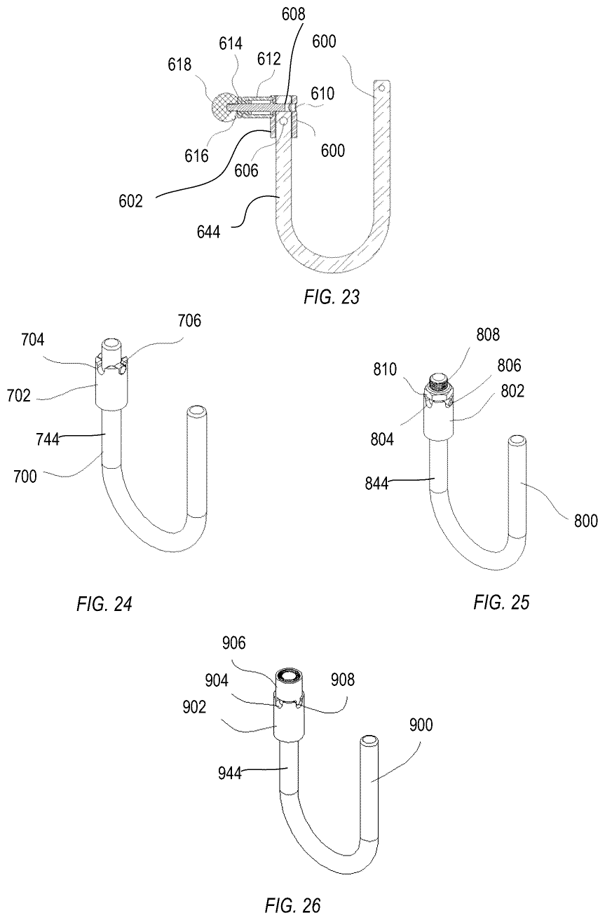

FIG. 24 illustrates another embodiment of a foldable hook 700 that may be used in various embodiments of chain storage devices. If the chain hanger hook 700 is a lid locking hook, the tip region of the chain hanger hook 700 may include an aperture or other feature configured to receive a pin, padlock, or other securing element.

In certain embodiments, a chain hanger assembly includes one or more chain hanger hook collars 702 mounted to a chain hanger support member, each hook collar 702 being configured to receive and support a shank 744 of a respective chain hanger hook 700. In such embodiments, the shank 744 extends at least partially through the corresponding hook collar 702. The hook collar 702 comprises a notched or castellated collar having a plurality of notches 704 formed therein. The chain hanger hook 700 includes a key in the form of a lock pin 706 passing therethrough and configured to selectively engage the notches 704. The hanger hook 700 may be repositioned via a lift-and-turn mechanism, wherein an operator lifts the hanger hook 700 upwardly to disengage the pin 706 from a notch 704, rotates the hanger hook 700 to a new angular or folded position, and then allows the hanger hook 700 to move downwardly so that the pin engages a corresponding notch 704.

FIG. 25 illustrates another embodiment of a foldable hook 800 that may be used in various embodiments of chain storage devices. If the chain hanger hook 800 is a lid locking hook, the tip region of the chain hanger hook 800 may include an aperture or other feature configured to receive a pin, padlock, or other securing element.

In certain embodiments, a chain hanger assembly includes one or more chain hanger hook collars 802 mounted to a chain hanger support member, each hook collar 802 being configured to receive and support a shank 844 of a respective chain hanger hook 700. In such embodiments, the shank 844 extends at least partially through the corresponding hook collar 802. The hook collar 802 comprises a notched or castellated collar having a plurality of notches 804 formed therein. The chain hanger hook 800 includes a key in the form of a lock pin 806 passing therethrough and configured to selectively engage the notches 804. The hanger hook 800 may be repositioned via a lift-and-turn mechanism, wherein an operator lifts the hanger hook 800 upwardly to disengage the pin 806 from a notch 804, rotates the hanger hook 800 to a new angular or folded position, and then allows the hanger hook 800 to move downwardly so that the pin engages a corresponding notch 804.

In the embodiment illustrated, the upper portion 808 of the shank 844 may be threaded. Thus, a nut 810 can be threaded onto the chain hanger hook 800 and advanced until it comes in contact and locks the pin 806 in place to prevent the pin 806 from sliding out of the chain hanger hook 800. The nut 810 and pin 806 can be removed to allow the hanger hook 800 to be removed from the collar 802.

FIG. 26 illustrates another embodiment of a foldable hook 900 that may be used in various embodiments of chain storage devices. If the chain hanger hook 900 is a lid locking hook, the tip region of the chain hanger hook 900 may include an aperture or other feature configured to receive a pin, padlock, or other securing element.

In certain embodiments, a chain hanger assembly includes one or more chain hanger hook collars 902 mounted to a chain hanger support member, each hook collar 902 being configured to receive and support a shank 944 of a respective chain hanger hook 900. In such embodiments, the shank 944 extends at least partially through the corresponding hook collar 902. The hook collar 902 comprises a notched or castellated collar having a plurality of notches 904 formed therein. The chain hanger hook 900 includes a press-fit or otherwise attached indexing cap 906 that includes a key 908 to selectively engage the notches 904. The hanger hook 900 may be repositioned via a lift-and-turn mechanism, wherein an operator lifts the hanger hook 900 upwardly to disengage the pin 906 from a notch 904, rotates the hanger hook 900 to a new angular or folded position, and then allows the hanger hook 900 to move downwardly so that the pin engages a corresponding notch 904. In some embodiments, the indexing cap 906 can be removed to allow the hanger hook 900 to be removed from the collar 902.

Embodiments of the tire chain storage devices disclosed herein, including chain storage devices 20, 120, 220, 320, 420, and 520, may incorporate modular and removable architectures that facilitate installation, seasonal removal, and off vehicle storage. In certain embodiments, a chain hanger mounting bracket may remain installed on the vehicle frame member while an associated chain hanger frame, support arm, or hook support member is removably detached, optionally with chain hanger hooks attached and, in some cases, with tire chains remaining supported thereon. The removed chain hanger frame or hook support structure may be mounted to a storage rack, shelf, or similar structure in a warehouse, garage, or other storage location for off season storage. In other embodiments, the chain hanger hooks are supported on a removable bar or cross member, permitting the hooks and chains to be removed as a unit.

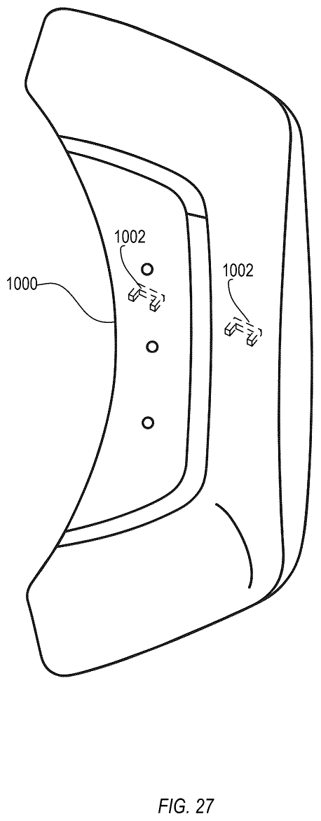

As discussed, it may be desirable to store the fairing on the tire chain hanger device if additional clearance is needed while operating the vehicle with chains. With reference to FIG. 27, in some embodiments, a fairing 1000, which may be an embodiment of fairing 70, may include one or more rings or eyes 1002 or other features that allow the fairing 1000 to hang from the tire chain hooks. The feature may include a mounting aperture dimensioned to receive a tire chain hook, allowing the fairing 1000 to be suspended from the tire chain hooks. When the tire chains are deployed (in-use), the fairing may occupy the hanger. In other example embodiments, the hooks may be sized so that the fairing can lay across the hooks when they are unoccupied by chains.

The tire chain storage devices may be configured for compatibility with aerodynamic systems and splash suppression systems. In some embodiments, the chain hanger mounting bracket is configured to be mounted using existing frame mounting locations, such as those used for mud flap hangers or fairing support arms. For example, a chain hanger mounting bracket may be sandwiched between the vehicle frame rail and an existing mud flap hanger or fairing support arm using the same mounting hardware, thereby allowing retrofit installation without drilling new holes in the vehicle frame. Slot based mounting apertures may be used to permit installation or removal by partially loosening existing fasteners.

The chain hanger support member may extend generally laterally from the frame and may support one or more additional vehicle components, such as mud flaps and aerodynamic fairings. Depending on the embodiment, the chain hanger support member may be rigidly fixed to the frame, spring biased to permit deflection relative to the frame, or attached using rotatable or telescoping interfaces, including toolless attachment mechanisms such as snap pins or quick release fasteners.

Aerodynamic fairings supported by the chain hanger support member may include rear fairings, quarter fairings, or other wheel adjacent aerodynamic devices. The fairing may be mounted directly to the support member or indirectly via an adapter, which may permit adjustment of fairing position, orientation, or offset relative to the vehicle frame. In some embodiments, fairing mounting brackets are pivotable or hinged, allowing the fairing to be moved between a primary aerodynamic position and a secondary clearance or stowed position when tire chains are installed or when additional clearance is required.

The chain hanger assembly includes one or more chain hanger hooks configured to support tire chains in a suspended condition. The hooks may be fixed, removable, rotatable, foldable, or indexed, depending on the embodiment. The hooks may be mounted directly to a chain hanger support member or indirectly via interchangeable hook collars. The number of hooks may vary.

Each chain hanger hook may include a shank, a bend region, and a return portion defining a throat for receiving a tire chain. Hooks may be formed from circular rod stock or rectangular or square bar stock, and may include reinforced or gusseted regions. The bend may be arcuate or formed by angular transitions. The hook tip may include a retention feature such as an aperture for receiving a locking pin or padlock.

In certain embodiments, the chain hanger hooks are supported by hook collars mounted to the chain hanger support member. The shank of each hook may extend through a corresponding collar and may include a retaining head to prevent withdrawal. The hook and collar may together define a controlled rotational or foldable interface, including indexed or clocked positioning. Such indexing may be accomplished using non circular shank geometries, splines, grooves, castellated collars, notches, keys, spring biased indexers, or lock pins, including lift and turn mechanisms. Hooks may be removable from the collars for replacement, seasonal removal, or storage.

Various specific foldable hook embodiments are disclosed, including hooks with pin indexed collars, castellated collars with key engagement, spring biased locking pins, threaded retainers, removable index caps, and removable locking hardware. These embodiments permit selective positioning of hooks between operational and folded positions while inhibiting free swinging during vehicle operation.

In certain embodiments, one or more chain hanger hooks may function as lid-locking hooks. A hanger lid may include one or more apertures that align with a hook tip in either an extended or folded hook position, allowing insertion of a locking element to secure the lid in a closed position.

The chain hanger assembly may further include a lid assembly comprising a hanger lid pivotably coupled to the chain hanger support member by a hinge. The lid may be hinged, removable, or both, and may be retained using quick-release pins, captive fasteners, latches, detents, cams, or similar mechanisms. The lid may be configured to enclose at least a portion of the hooks and chains when closed and may include hook access apertures for lid locking.

The hanger lid may be formed from metal, polymer, composite, or other suitable materials, and in some embodiments includes a contoured or aerodynamic outer profile to improve airflow relative to flat or box-shaped lids. The lid may be configured for interchangeability between left-side and right-side installations.

The embodiments described herein are illustrative and not limiting. Numerous modifications, combinations, and variations may be made without departing from the scope of the claims, including variations in mounting configurations, hook types, fairing arrangements, lid constructions, and component interchangeability.

Thus embodiments include tire chain storage devices for use on vehicles, particularly heavy-duty vehicles such as a semi-trucks. According to one embodiment, a tire chain storage device includes a chain hanger support, such as a chain hanger support assembly, configured for attachment to a frame member of the vehicle, and a chain hanger assembly supported by the support assembly. The chain hanger assembly includes a plurality of chain hanger hooks configured to support tire chains in a suspended condition. A mounting bracket secures the chain hanger support assembly to the vehicle frame. In some embodiments, the tire chain storage device may be mounted adjacent to a drive wheel of the vehicle.

In certain embodiments, the chain hanger support assembly includes the mounting bracket and a hanger support member, which may extend generally laterally outward from the vehicle frame. The support member may be separable from the mounting bracket, and in some implementations, the support member is removably attachable to the mounting bracket without the use of tools. By way of example, the hanger support member may be telescopically received within the mounting bracket and retained in position by a removable pin or similar quick-release element.

In some embodiments, the mounting bracket is configured to be positioned between the vehicle frame member and another vehicle component, such as a mud flap hanger or an aerodynamic fairing support arm. The mounting bracket may include mounting apertures aligned with mounting hardware of the mud flap hanger or fairing support arm, enabling both components to be secured using the same fasteners. In further embodiments, the mounting bracket includes one or more open-ended mounting slots, allowing the tire chain storage device to be installed or removed without fully removing existing mounting hardware from the frame member. In some embodiments, such a chain storage device may include a fairing mounting interface for mounting an aerodynamic fairing. Thus, for example, a chain storage device may be used in conjunction with an existing mud flap hanger while supporting an aerodynamic fairing. Alternatively, a chain storage device may be used in conjunction with an existing fairing support arm while supporting a mud flap.

The tire chain storage device may include integration with aerodynamic components. In some embodiments, the hanger support member includes a fairing mounting interface configured to support an aerodynamic fairing, such as a rear fairing or a quarter fairing. The fairing mounting interface may be fixed, adjustable, or removable. In certain embodiments, the fairing mounting interface includes a pivotable or hinged bracket allowing the fairing to move between a primary aerodynamic position and a secondary clearance or stowed position. In addition, the fairing mounting interface may include an adapter that permits the fairing to be mounted in a plurality of selectable positions or orientations.

The chain hanger assembly includes one or more chain hanger hooks. One or more of the chain hanger hooks may be removable from the chain hanger assembly. In certain embodiments, one or more chain hanger hooks are rotatable or foldable between an operational position, in which tire chains are supported, and a storage position, in which the hook occupies a reduced profile. In some embodiments, a rotatable or foldable hook is supported by a collar defining a plurality of indexed positions.

The indexing system may take various forms. For example, the hook collar may include a castellated collar, a splined interface, a non-circular engagement between a hook shank and the collar, or a pin-indexed locking arrangement. In some embodiments, the foldable or rotatable hook is biased toward a locked position by a spring-loaded indexing mechanism, such that the hook must be lifted or otherwise actuated to change its angular position.

Each chain hanger hook may include a shank, a bend, and a return portion forming a throat configured to receive a tire chain. Hooks may be fabricated from rod stock having a generally circular cross-section, or from bar stock having a rectangular or square cross-section.

The tire chain storage device may further include a lid assembly coupled to the chain hanger assembly. The lid assembly may be movable between an open position and a closed position, and in some embodiments the lid assembly is removably coupled to the chain hanger assembly without tools. The lid assembly may include one or more hook access apertures aligned with one or more chain hanger hooks.

The chain hanger assembly may be removable from the vehicle as a unit with the chain hanger hooks attached. In some embodiments, the chain hanger assembly may be removed with tire chains remaining supported on the hooks, allowing the entire assembly to be stored off the vehicle during an off-season.

In some embodiments, the chain hanger support assembly and associated components are configured for use in both left-side and right-side vehicle installations. Components such as the chain hanger support assembly, lid assembly, or chain hanger hooks may be interchangeable between left-hand and right-hand installations.

Embodiments may include a method of storing tire chains on a vehicle. The method may include mounting a chain hanger support assembly to a vehicle frame member and supporting tire chains on a plurality of chain hanger hooks. The method may include selectively repositioning at least one of a chain hanger hook or an aerodynamic fairing between an operational position and a storage or clearance position. Methods may further include storing a chain hanger device off-vehicle. In some embodiments, the chains are still stored on the chain hanger device off-vehicle.

As used herein, the terms “comprises,” “comprising,” “includes,” “including,” “has,” “having” or any other variation thereof, are intended to cover a non-exclusive inclusion. For example, a process, product, article, or apparatus that comprises a list of elements is not necessarily limited to only those elements but may include other elements not expressly listed or inherent to such process, product, article, or apparatus. Further, unless expressly stated to the contrary, “or” refers to an inclusive “or” and not to an exclusive “or”. For example, a condition A or B is satisfied by any one of the following: A is true (or present) and B is false (or not present), A is false (or not present) and B is true (or present), and both A and B are true (or present).

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

What is claimed is:

1. A tire chain storage device, comprising:
a chain hanger support configured for attachment to a frame member of a vehicle, the chain hanger support comprising:
a chain hanger support member;
a mounting bracket configured to secure the chain hanger support to the frame member; and
a fairing mounting interface for mounting a fairing to the chain hanger support; and
a chain hanger assembly mounted to the chain hanger support and comprising a plurality of chain hanger hooks configured to support tire chains in a suspended condition.

2. The tire chain storage device of claim 1, wherein the chain hanger support comprises a mudflap support.

3. The tire chain storage device of claim 2, wherein the chain hanger support is adapted to hang an angled mud flap.

4. The tire chain storage device of claim 1, wherein the chain hanger support member comprises an extension bracket, wherein the extension bracket is rotatable from a primary position corresponding to a fairing aerodynamic position to a secondary position.

5. The tire chain storage device of claim 4, wherein the extension bracket is lockable in at least one of the primary position or the secondary position.

6. The tire chain storage device of claim 5, wherein the extension bracket comprises a working end carrying the fairing mounting interface and a heel, wherein the heel is releasably securable when the extension bracket is in the primary position.

7. The tire chain storage device of claim 1, wherein the fairing mounting interface is configured to mount at least one of a rear fairing or a quarter fairing.

8. The tire chain storage device of claim 1, wherein the fairing can be stored on the tire chain storage device in two or more locations on the tire chain storage device.

9. A system comprising:
a modular a tire chain storage device, the modular tire chain storage device comprising:
a chain hanger support member, the chain hanger support member comprising an extension bracket, wherein the extension bracket comprises at least one of the following: a fairing mounting interface or a support area for attachment of a mud flap;
a mounting bracket configured to secure the chain hanger support member to a frame member of a vehicle; and
a chain hanger assembly mounted to the chain hanger support member and comprising a plurality of chain hanger hooks configured to support tire chains in a suspended condition.

10. The system of claim 9, wherein the extension bracket comprises the fairing mounting interface and the support area for attachment of the mud flap.

11. The system of claim 9, wherein the chain hanger support member comprises a first support member having an inboard end coupled to the mounting bracket, wherein the extension bracket is coupled to the first support member.

12. The system of claim 11, wherein at least one of the first support member or the mounting bracket is symmetrically configured such that its geometry is orientation-independent relative to a vertical transverse plane of the vehicle.

13. The system of claim 9, wherein at least one of the chain hanger hooks is removable.

14. The system of claim 9, wherein at least one of the chain hanger hooks is rotatable between an operational position and a storage position.

15. The system of claim 14, further comprising a hook collar defining a plurality of indexing notches, wherein a first chain hanger hook from the plurality of chain hanger hooks comprises:
a shank that passes through the hook collar; and
a keying feature, and wherein the first chain hanger hook is movable between the operational position in which the keying feature is matingly engaged with a first indexing notch and the storage position in which the keying feature is matingly engaged with a second notch.

16. The system of claim 14, further wherein the modular tire chain storage device comprises a hanger lid, wherein a first chain hanger hook from the plurality of chain hanger hooks has a tip and wherein the hanger lid defines:
a first hook access aperture adapted to align with the tip of the first chain hanger hook when the first chain hanger hook is in the operational position; and
a second hook access aperture adapted to align with the tip of the first chain hanger hook when the first chain hanger hook is in the storage position.

17. The system of claim 9, wherein the chain hanger support member is separable from the mounting bracket, and wherein the chain hanger assembly is configured to be removable from the vehicle as a unit with the chain hanger hooks attached.

18. The system of claim 9, wherein the chain hanger assembly is configured to be stored off-vehicle with tire chains supported thereon.

19. The system of claim 9, wherein the mounting bracket includes one or more open-ended mounting slots configured to permit installation without removing existing mounting hardware from the frame member.

20. The system of claim 9, further comprising a spring-loaded mudflap hanger mounted to the modular tire chain storage device.

21. A tire chain storage device, comprising:
a chain hanger support configured for attachment to a frame member of a vehicle, the chain hanger support comprising:
a first support member;
a mounting bracket configured to secure the chain hanger support to the frame member, wherein at least one of the first support member or the mounting bracket is symmetrically configured such that its geometry is orientation-independent relative to a vertical transverse plane of the vehicle; and
a chain hanger assembly mounted to the chain hanger support and comprising a plurality of chain hanger hooks configured to support tire chains in a suspended condition.
